(19) United States
(12) Patent Application Publication
(10) Pub. No.: US 2012/0050382 A1
(43) Pub. Date: Mar. 1, 2012

(54) INK JET INK COMPOSITION, INK JET RECORDING METHOD, INK CARTRIDGE, RECORDING UNIT, AND INK JET RECORDING APPARATUS

(76) Inventors: Yasuhiro Tanaka, Kanagawa (JP); Ikuko Tsurui, Kanagawa (JP)

(21) Appl. No.: 13/212,491

(22) Filed: Aug. 18, 2011

(30) Foreign Application Priority Data
Aug. 26, 2010 (JP) P2010-189255

(51) Int. Cl. B41J 2/175; C09D 11/02

(52) U.S. Cl. 347/20; 106/31.48; 106/31.45; 347/86

(57) ABSTRACT

Provided is an ink jet ink composition including at least: a first color material which is a bisazo compound, a second color material which is a trisazo compound, a third color material which is a tetraazo compound, and a surfactant.

### BACKGROUND

The present disclosure relates to an ink jet ink composition, an ink jet recording method, an ink cartridge, a recording unit, and an ink jet recording apparatus.

An ink jet recording system is a system in which ink droplets are formed and a part or whole of the small ink droplets are attached to recorded materials such as paper and the like to perform recording. This system is expected to be an output method for an image which replaces silver halide photographs with the rapid spread of digital cameras. For this reason, more than ever there is a demand for an image obtained by an ink jet recording method to have improved fastness which blocks color fading by light or gases such as ozone and the like as well as a high image quality.

Many proposals have been made for the purpose of improving the fastness. For example, Japanese Unexamined Patent Application Publication No. 2004-315741 proposes a predetermined trisazo compound or a salt thereof as a colorant which is excellent in ozone gas resistance, light resistance, moisture resistance, and a color rendering property.

Furthermore, Japanese Unexamined Patent Application Publication No. 2005-139427 proposes a bisazo dye having a total number of more than 12 aromatic conjugated it electrons, not linked directly to an azo group, as a black dye having both of high fastness and a color developing property.

Moreover, Japanese Unexamined Patent Application Publication No. 2005-146244 proposes a coloring composition, which has good color and is capable of improving fastness against light and active gases, particularly, ozone gas, in the environment, as a black dye by the combined use of a disazo dye having a specific structure and an azo dye having a specific structure.

Furthermore, Japanese Unexamined Patent Application Publication No. 2007-302801 proposes a black ink composition, in which a specific two azo colorants are used in combination at a specific ratio and C. I. Direct Yellow 86 is used as a third dye. This black ink composition makes it possible to obtain a neutral and good color tone while maintaining the fastness, gain a remarkable bronzing inhibitory effect, and maintain the state of black color that is developed favorably over a long period of time.

In addition, Japanese Unexamined Patent Application Publication No. 2008-248173 is an another example of the above-described related art.

### SUMMARY

Meanwhile, in the ink jet recording method, maintenance which enables recovery from a state in which a head is left to stand for a long period time is performed, but from the viewpoint of increasing a printing speed, it is important to shorten the time necessary for the maintenance. For this reason, the ink used in the ink jet recording method (hereinafter described as the “ink jet ink”) is necessary to have a maintenance saving property for shortening the maintenance time. Particularly, in order to perform high-speed printing, it is important to reduce the frequency of a recovery treatment, called empty discharging, which is one of the maintenance methods.

The empty discharging refers to a recovery treatment in which ink not contributing to the printing of an image from a discharging head to a target recording medium is discharged and the discharging state of the ink becomes favorable. This empty discharging is effective in the case where the discharging rate of the ink slows down and the discharging direction varies by increasing the viscosity of the ink near a nozzle for a few seconds to a few tens of seconds when the printing is paused with the nozzle uncapped, but extra time for the empty discharging is further necessary. In contrast, it is thought that even when the printing pause time is long, the empty discharging frequency can be reduced and the printing time can be shortened by using the ink providing a good image quality.

Furthermore, as a recording system of the ink jet recording method, there is a thermal ink jet recording system in which ink is discharged from a recording head by applying thermal energy to perform recording. In this thermal ink jet recording system, it is known that the durability is deteriorated by attachment of carbides on a heating element, called cogation by ink, or on the contrary, occurrence of disconnection caused by the heating elements which are subjected to etching. Therefore, an approach for attaining durability for the heating elements can be mentioned as a performance necessary for an ink jet ink.

Accordingly, although various performances are necessary for the ink jet ink, it is important to control the ink penetration rate into a recording medium in order to obtain an image having a high image quality. As a method for controlling the ink penetration rate, it is known, for example, to add a material called a penetration aid or a surfactant. In particular, an acetylene glycol-based surfactant as a surfactant used in the ink jet ink has excellent characteristics such as an excellent ability of controlling a penetration rate, few side-effects on the durability for a heating element, and the like.

However, it was demonstrated by investigation of the present inventors that in the case where the acetylene glycol-based surfactant having excellent characteristics is used in combination with a specific dye, the surfactant does not sufficiently exert its surface-active performance. This problem occurs, specifically in the case where an ethylene oxide adduct of acetylene glycol is used as a surfactant in the ink composition containing a specific bisazo dye and a specific tetraazo dye, described in Japanese Unexamined Patent Application Publication No. 2005-146244 and Japanese Unexamined Patent Application Publication No. 2007-302801 above. The mechanism with which the problem occurs is unclear, but it can be seen that since the surface-active performance is not sufficiently exerted, the penetration rate of the ink into a recording medium is low and the color bleeding property is deteriorated, and as a result, a high-quality image is not obtained.

Here, in order to sufficiently secure the permeability of the ink into the target recording medium, a method in which a larger amount of a surfactant is added, as compared with the cases of using other dyes, is considered. However, it was proved that if the amount of the additives such as a surfactant and the like is increased, the printing pause time acceptable for obtaining good printing is remarkably shortened and the intermittent discharging stability is deteriorated. In addition, it could be seen that there occurs a problem that an increased amount of the additives causes decreased durability for the heating element due to cogation or etching.

Therefore, it is desirable to provide an ink jet ink composition, which is capable of printing an image having excellent fastness with a high image quality and has excellent intermittent discharging stability. Further, it is also desirable to provide an ink jet recording method, an ink cartridge, a recording unit, and an ink jet recording apparatus, in each of which an image having excellent fastness with a high image quality is obtained by using the ink jet ink composition.

According to an embodiment of the present disclosure, there is provided an ink jet ink composition, including at least a first color material which is a bisazo compound represented by the following general formula (I), a second color material which is a trisazo compound represented by the following general formula (II), a third color material which is a tetraazo compound represented by the following general formula (III), and a surfactant which is a compound having a structure represented by the following general formula (IV), in which the surfactant is contained in an amount of 0.10% by mass or more and less than 0.80% by mass.

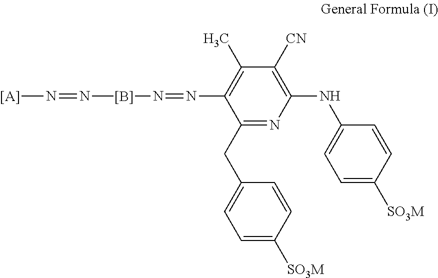

In the general formula (I), [A] is a group represented by any one of the following general formulae (1) to (4), [B] is a group represented by any one of the following general formulae (5) to (9), and each M is independently a hydrogen atom, an alkali metal, ammonium, or organic ammonium.

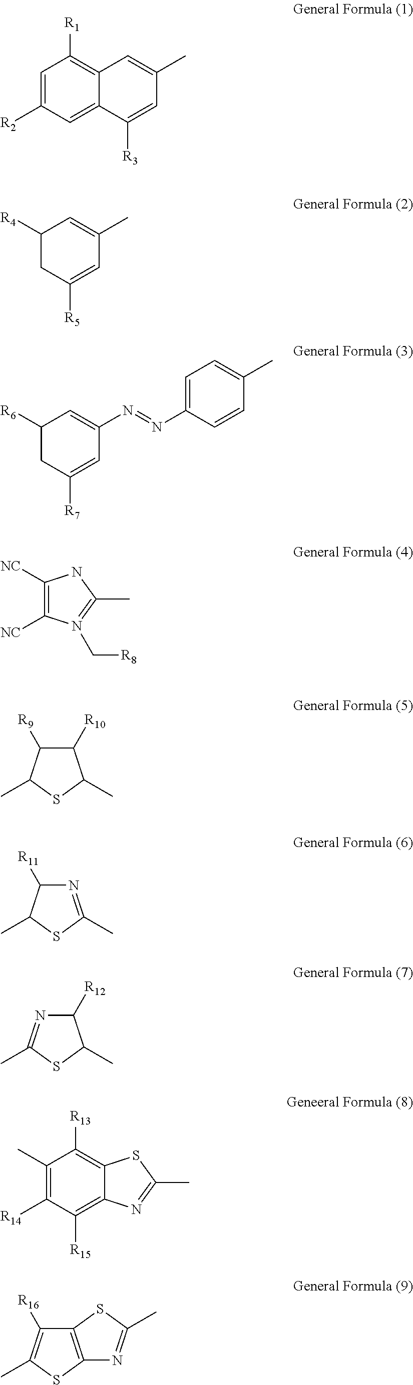

In the general formulae (1) to (9), R₁ to R₁₆ are each independently a hydrogen atom, a halogen atom, an aliphatic group, an aromatic group, a heterocyclic group, a carboxyl group, a carbamoyl group, an alkoxycarbonyl group, an aryloxycarbonyl group, a heterocyclic oxycarbonyl group, an acyl group, a hydroxyl group, an alkoxy group, an aryloxy group, a heterocyclic oxy group, a silyloxy group, an acyloxy group, a carbamoyloxy group, an alkoxycarbonyloxy group, an aryloxycarbonyloxy group, an aniline group, an amino group including a heterocyclic amino group, an acylamino group, a ureido group, a sulfamoylamino group, an alkoxycarbonylamino group, an aryloxycarbonylamino group, an alkylsulfonylamino group, an arylsulfonylamino group, a heterocyclic sulfonylamino group, a cyano group, a nitro group, an alkylthio group, an arylthio group, a heterocyclic thio group, an alkylsulfonyl group, an arylsulfonyl group, a heterocyclic sulfonyl group, an alkylsulfinyl group, an arylsulfinyl group, a heterocyclic sulfinyl group, a sulfamoyl group, or a sulfonic acid group, each of which may be further substituted.

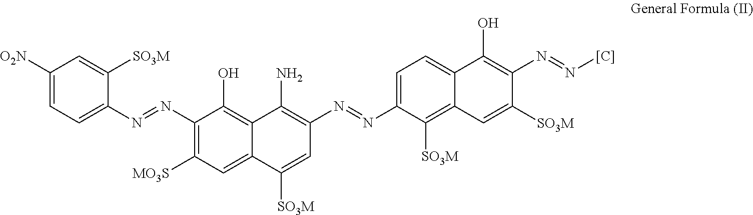

In the general formula (II), [C] is a phenyl group or a naphthyl group. The phenyl group and the naphthyl group may be substituted with a halogen atom, a carboxyl group, a sulfo group, an alkyl group, a phenyl group, a sulfamoyl group, or a nitro group. Further, each M is independently a hydrogen atom, an alkali metal, ammonium, or organic ammonium.

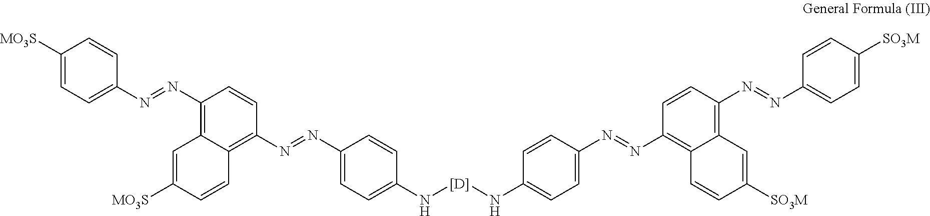

In the general formula (III), the bridge [D] has the following general formula (10) or (11), and each M is independently a hydrogen atom, an alkali metal, ammonium, or organic ammonium.

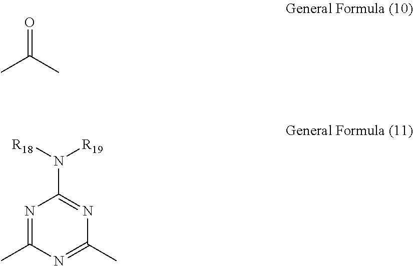

In the general formula (II), R₁₈ and R₁₉ are each independently a hydrogen atom or a monovalent substituent.

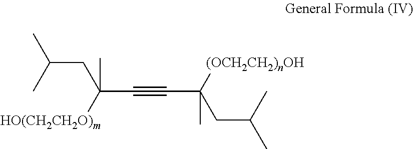

In the general formula (IV), m and n are an integer of 1 or more.

In the first color material represented by the general formula in the ink jet ink composition (I), [A] may be any one group represented by the following general formula (12) or the following general formula (13), and [B] may be any one group represented by the following general formula (14) or the following general formula (15).

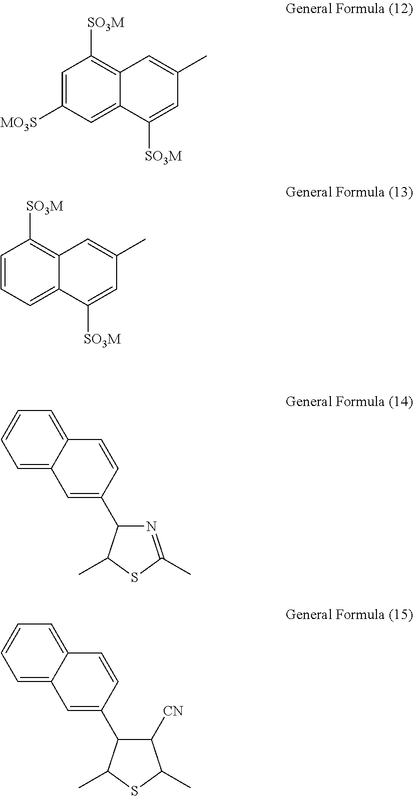

In the general formula (12) and the general formula (13), each M is independently a hydrogen atom, an alkali metal, ammonium, or organic ammonium.

In the ink jet ink composition, the second color material may be a compound represented by the following general formula (V).

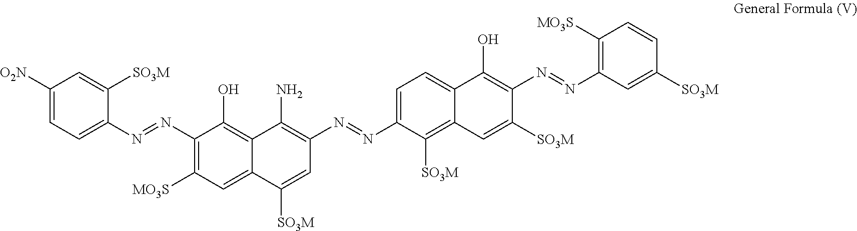

In the general formula (V), each M is independently a hydrogen atom, an alkali metal, ammonium, or organic ammonium.

In the ink jet ink composition, the total content of the first color material, the second color material, and the third color material in the ink composition is preferably 3.00% by mass or more and 6.00% by mass or less.

In the ink jet ink composition, the content (% by mass) of the first color material in the ink composition is preferably 0.50 times or more and 6.00 times or less the content (% by mass) of the second color material in the ink composition in terms of a mass ratio. Further, the total content (% by mass) of the first color material and the second color material in the ink composition is preferably 4.00 times or more and 6.00 times or less the content (% by mass) of the third color material in the ink composition in terms of a mass ratio.

In the ink jet ink composition, the surfactant preferably has an HLB (Hydrophile-Lipophile Balance) value of 10 or more.

The ink jet ink composition may further contain a pH adjuster in an amount of 0.10% by mass or more and less than 0.50% by mass.

In the ink jet ink composition, the pH adjuster is preferably a 3-morpholinopropanesulfonic acid.

Furthermore, according to another embodiment of the present disclosure, there is provided an ink jet recording method, including discharging liquid droplets of an ink composition by an ink jet system to perform recording, wherein the ink composition includes at least a first color material which is a bisazo compound represented by the general formula (I), a second color material which is a trisazo compound represented by the general formula (II), a third color material which is a tetraazo compound represented by the general formula (III), and a surfactant which is a compound having a structure represented by the following general formula (IV), in which the surfactant is contained in an amount of 0.10% by mass or more and less than 0.80% by mass.

Furthermore, according to still another embodiment of the present disclosure, there is provided an ink cartridge, including an ink-storing unit for storing an ink jet ink composition including at least a first color material which is a bisazo compound represented by the general formula (I), a second color material which is a trisazo compound represented by the general formula (II), a third color material which is a tetraazo compound represented by the general formula (III), and a surfactant which is a compound having a structure represented by the general formula (IV), in which the surfactant is contained in an amount of 0.10% by mass or more and less than 0.80% by mass.

Furthermore, according to still another embodiment of the present disclosure, there is provided a recording unit, including an ink cartridge having an ink-storing unit for storing an ink jet ink composition including at least a first color material which is a bisazo compound represented by the general formula (I), a second color material which is a trisazo compound represented by the general formula (II), a third color material which is a tetraazo compound represented by the general formula (III), and a surfactant which is a compound having a structure represented by the general formula (IV), in which the surfactant is contained in an amount of 0.10% by mass or more and less than 0.80% by mass, and a recording head for discharging liquid droplets of the ink composition stored in the ink-storing unit.

Furthermore, according to still another embodiment of the present disclosure, there is provided an ink jet recording apparatus, including an ink cartridge having an ink-storing unit for storing an ink jet ink composition including at least a first color material which is a bisazo compound represented by the general formula (I), a second color material which is a trisazo compound represented by the general formula (II), a third color material which is a tetraazo compound represented by the general formula (III), and a surfactant which is a compound having a structure represented by the general formula (IV), in which the surfactant is contained in an amount of 0.10% by mass or more and less than 0.80% by mass, and a recording head for discharging liquid droplets of the ink composition stored in the ink-storing unit.

According to the embodiment of the present disclosure, an ink jet ink composition, which is capable of printing an image having excellent fastness with a high image quality and has an excellent intermittent discharging property and a preferable color tone as a black ink, can be provided. Further, according to the embodiments of the present disclosure, an ink jet recording method, an ink cartridge, a recording unit, and an ink jet recording apparatus, in each of which an image having excellent fastness with a high image quality is obtained by using the ink jet ink composition, can be provided.

### BRIEF DESCRIPTION OF THE DRAWINGS

FIG. 1 is an exploded perspective view showing an example of the entire constitution of an ink jet recording apparatus according to a suitable embodiment of the present disclosure.

FIG. 2 is an exploded perspective view showing the constitution of a head cartridge provided in the ink jet recording apparatus 100 of FIG. 1.

FIG. 3 is a cross-sectional view obtained by cutting the head cartridge shown in FIG. 2 along the line.

FIGS. 4A and 4B are cross-sectional views showing the constitution of the recording head provided in the head cartridge shown in FIG. 3, in which 4A schematically shows the state of bubbles generated on a heating element and 4B schematically shows the state of ink droplets discharged from a nozzle.

### DETAILED DESCRIPTION OF EMBODIMENTS

With reference to the accompanying drawings below, suitable embodiments of the present disclosure will be described in detail. Further, in the specification and drawings, the same constituting elements having substantially the same function constitutions are attached with the same symbols to omit duplicate explanation.

Furthermore, description will be made in the following order:

1. Problems of Related Art and Investigation of Means for Solving the Problems

2. Ink Jet Ink Composition According to Suitable Embodiment of the Disclosure

3. Ink Jet Recording Method According to Suitable Embodiment of the Disclosure

4. Ink Cartridge According to Suitable Embodiment of the Disclosure

5. Recording Unit According to Suitable Embodiment of the Disclosure

6. Ink Jet Recording Apparatus According to Suitable Embodiment of the Disclosure

7. Conclusion

### 1. Problems of Related Art and Investigation of Means for Solving the Problems

First, before describing the ink jet ink composition and the like according to a suitable embodiment of the present disclosure, the problems of the related art discovered by the present inventors and novel knowledge obtained by investigation of the present inventors will be described.

### 1.1. Problems of Related Art

As described above, in recent years, there has been a demand for an increasing level of fastness of a dye (color material) used in the ink employed for an ink jet recording method. Thus, the present inventors have investigated an ink composition containing a bisazo dye having a structure of the following general formula (I) and a tetraazo dye having a structure of the following general formula (III) from the combination with an azo dye having excellent fastness described in Japanese Unexamined Patent Application Publication No. 2005-146244 and Japanese Unexamined Patent Application Publication No. 2007-302801.

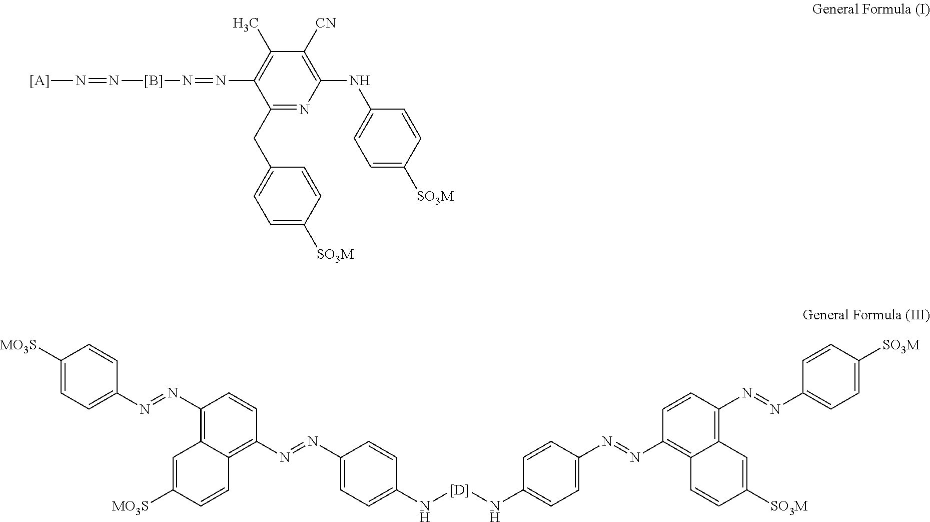

Here, an acetylene glycol-based surfactant has an excellent ability of controlling the penetration rate of ink as well as few side-effects on durability on a heating element, as described above. However, it was confirmed that when an ethylene oxide adduct of acetylene glycol which is one of acetylene glycol-based surfactants (refer to the following general formula (IV)) was chosen as a surfactant which is added to an ink composition containing the azo dye, the surface-active performance is not sufficiently exerted. The mechanism of this phenomenon is unclear, but it could be seen that the surface-active performance is not sufficiently exerted, and accordingly, the penetration rate of the ink composition into a recording medium is low and the color bleeding property is deteriorated, leading to occurrence of a problem that a high-quality image is not obtained.

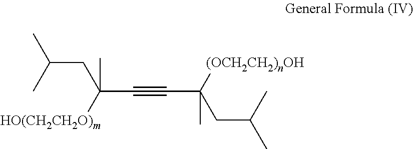

With respect to the problems, in order to sufficiently secure the permeability of the ink composition into a recording medium, an approach in which more surfactants are added, as compared with a case of using other dyes, is considered. However, it could be seen that if the content of the additives such as a surfactant and the like in the ink composition is increased, there occurs a problem that a printing pause time acceptable for obtaining a good image is remarkably shortened, and thus, the intermittent discharging stability is deteriorated. In addition, it could be seen that an increased amount of the additives such as a surfactant and the like caused the durability for a heating element to be lowered due to cogation or etching.

Furthermore, Japanese Unexamined Patent Application Publication No. 2009-256601 proposes a black ink having a combination of a dye having the structure of the general formula (I), an azo dye which is an aromatic compound having a sulfo group, and an acetylene glycol-based surfactant represented by the general formula (IV). In Japanese Unexamined Patent Application Publication No. 2009-256601, there is a description that the black ink has excellent gas resistance and ozone resistance, but there is no discussion of an effect of the penetration rate into a recording medium in the case of the addition of a surfactant.

Moreover, Japanese Unexamined Patent Application Publication No. 2008-24909 points out a problem on sticking resistance or intermittent discharging stability in ink in which a dye having the structure of the general formula (I) is used. To solve the problem, Japanese Unexamined Patent Application Publication No. 2008-24909 proposes to use bis(2-hydroxyethyl)sulfone. However, according to Examples thereof, a larger amount (0.8% by mass or more) of an acetylene glycol-based surfactant than that usually preferably used is added. Thus, in Japanese Unexamined Patent Application Publication No. 2008-24909, the level at which the intermittent discharging stability is considered good, specifically, the non-discharging time for obtaining good discharging (printing pause time) is merely around 3 seconds or more. At this level of the non-discharging time, the intermittent discharging stability is not sufficient for high-speed printing.

On the other hand, it is clear that even when the amount of the acetylene glycol-based surfactant to be added is 0.1% by mass or more and 0.8% by mass or less, which is a usually preferably used amount, in order to obtain sufficient permeability into a recording medium, good intermittent discharging stability is obtained even for a long period of time such as a printing pause time of well over 10 seconds.

### 1.2. Investigation of Means for Solving the Problems

Therefore, the present inventors have extensively conducted studies in order to obtain an ink jet ink composition, which is capable of printing an image having excellent fastness with a high image quality and has excellent intermittent discharging stability as well as a preferable color tone as a black ink as well as excellent durability for a heating element. Hereinbelow, the results of the investigation will be described in detail.

(1.2.1. Investigation on Intermittent Discharging Stability)

First, the present inventors have investigated an ink jet ink composition, in which a bisazo compound (dye) of the general formula (I) and a tetraazo compound (dye) of the general formula (III) are used in combination as a color material in order to obtain an ink composition having good black color, excellent fastness against light and active gases (particularly ozone gas) in the environment, and inhibited gloss bronzing. As a result, a phenomenon that if these two dyes are used in combination with an acetylene glycol-based surfactant represented by the general formula (IV), the surface-active performance of the acetylene glycol-based surfactant is not sufficiently exerted, although the mechanism is unclear, was confirmed. From this, it could be seen that if these two dyes are used in combination, the ink penetration rate is lowered, the color bleeding property becomes poor, and a high-quality image is not obtained, although the same amount of the acetylene glycol-based surfactant is used as in the cases where other dyes are used.

With respect to these problems, it could be seen that when the amount of the surfactant to be added is set to 0.80% by mass or more based on the total amount of the ink composition in order to sufficiently secure the penetration rate of the ink into the recording medium, the penetration rate is high and a high-quality image without generation of bleed or the like is obtained. However, it was proved that if the amount of the additives such as a surfactant and the like is increased, the intermittent discharging stability is deteriorated, that is, a printing pause time acceptable for obtaining a good image is remarkably shortened.

Therefore, the present inventors have investigated improving the intermittent discharging stability of the ink composition without increasing the amount of the surfactant to be added. As a result, they have solved the above-described problems by adding the trisazo compound (dye) represented by the following general formula (II) to an ink composition containing the bisazo compound of the general formula (I), the tetraazo compound of the general formula (III), and the acetylene glycol-based surfactant of the general formula (IV). That is, the present inventors have found that by the combined use of the compound represented by the general formula (I) and the compound represented by the general formula (II), a smaller amount of an acetylene glycol-based surfactant can lower the surface tension, as compared with a case where the compound of the general formula (I) is used alone. It was confirmed chat this effect is also maintained even when the compound of the general formula (III) exists. This effect is not fully discussed in Japanese Unexamined Patent Application Publication No. 2005-146244, Japanese Unexamined Patent Application Publication No. 2007-302801, Japanese Unexamined Patent Application Publication No. 2009-256601, and Japanese Unexamined Patent Application Publication No. 2008-24909 above, but the present inventors have found that the effect is a phenomenon occurring specifically in the case of the combined use of the compound represented by the general formula (I) and the compound represented by the general formula (II).

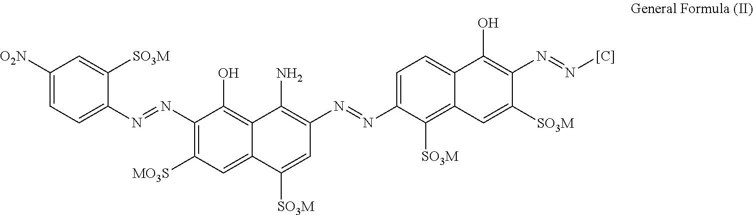

As described above, the present inventors have contemplated an ink composition containing the bisazo compound represented by the general formula (I), the trisazo compound represented by the general formula (II), the tetraazo compound represented by the general formula (III), and the acetylene glycol-based surfactant represented by the general formula (IV). In the ink composition according to the embodiment of the present disclosure, the acetylene glycol-based surfactant is added in approximately the same amount as the amount usually employed in the cases where other dyes are used, that is, in an amount in the range of 0.10% by mass or more and less than 0.80% by mass, based on the total amount of the ink composition. Accordingly, in the ink composition according to the embodiment of the present disclosure, an excess amount of the additive does not cause a problem that the intermittent discharging stability is deteriorated. Further, the ink composition according to the embodiment of the present disclosure has a good black color and excellent fastness against light and active gases (particularly ozone gas) in the environment. Therefore, by using the ink composition according to the embodiment of the present disclosure in an ink jet recording method, the ink droplets can be discharged well even with a long printing pause time, a load on maintenance can be reduced and an image having excellent fastness with a high image quality can be stably obtained.

(1.2.2. Investigation on Fastness and the like of Color Material)

Next, as a result of investigation by the present inventors, it was proved that in the case of adding the compound of the general formula (II) in order to provide high intermittent discharging stability, an effect obtained by mixing and using the compound of the general formula (I) and the compound of the general formula (III) is not interfered. That is, by the ink composition according to the embodiment of the present disclosure, there is a remarkable effect that generation of a bronzing phenomenon of the printed matter printed by an ink jet recording method, and an effect that the light resistance and the ozone resistance (fastness) are excellent and a neutral and preferable color tone is obtained was confirmed. Further, it was also confirmed that high intermittent discharging stability can be provided even if the acetylene glycol-based surfactant is used in combination while maintaining the above-described effect.

(1.2.3. Investigation on Recording Durability)

Furthermore, the present inventors have found that by setting the total content of the compound of the general formula (I), the compound of the general formula (II), and the compound of the general formula (III), each contained as a color material in the ink composition, or the content of the compound of the general formula (IV) to specific ranges, an additional effect is obtained. That is, it can be seen that in the ink composition according to the embodiment of the present disclosure, by setting the total content of all the color materials or the content of the surfactant to specific ranges, the penetration rate of the ink is high, the bleeding is inhibited, and the intermittent discharging stability is further improved. In addition, it could be seen that by setting the content of all the color materials or the surfactant to specific ranges, in the case where the ink composition according to the embodiment of the present disclosure is applied in a thermal ink jet recording system in which ink is discharged by applying thermal energy, disconnection of a heater (heating element) of a recording head is more effectively inhibited.

(1.2.4. Investigation on Color Tone and Recording Medium Selectivity)

Moreover, as a result of investigation by the present inventors, it could be seen that there occurs a problem that in the case of the combined use of the first color material represented by the general formula (I) and the third color material represented by the general formula (III), when the mixing ratio of the first color material to the third color material, providing a neutral and preferable color tone, is determined, the color tones are different in glossy paper and plain paper. It is thought that the first color material has a bluish black color tone and is incompatible with plain paper, whereas the second color material has a yellowish black color tone and is compatible with plain paper. That is, in the case of a ratio giving a neutral and preferable color tone by performing the printing on glossy paper, yellowness gets stronger on plain paper, whereas in the case of a ratio giving a neutral and preferable color tone by performing the printing on plain paper, blueness gets stronger on glossy paper.

On the contrary, the second color material represented by the general formula (II) has a bluish black color tone close that of the first color material, but is compatible with plain paper. For this reason, by mixing the first color material, the second color material, and the third color material, and using them, the difference in the color tones between the plain paper and the glossy paper is not significant and does not depend on the kind of the recording medium, and an ink jet black ink giving a neutral and preferable color tone is obtained. In addition, by setting the mixing ratios of the first color material through the third color material to specific ranges, it becomes possible that the fastness of an image and the intermittent discharging stability of the ink are excellent, a high-quality image is obtained, and an ink composition having a neutral and preferable color tone as a black ink is prepared.

Here, the neutral and preferable black color tone as mentioned in the present disclosure specifically has the following meaning. That is, the black ink is used and an image with a recording duty varying from 0% to 100% at an interval of 10% is measured for the values of L*, a*, and b* in the L*a*b* color system defined by the CIE (International Commission on Illumination) and an optical density. Further, from the resulting values of L*, a*, and b*, it is examined whether an image having a recording duty of 100% satisfies a condition of 0≦L*≦40, and whether all the images having a recording duty of 10% to 100% satisfy a condition of −15≦a*≦15 and −15≦b*≦15. As a result, in the present disclosure, the ink composition which is demonstrated to satisfy the above-described condition indicates an ink composition having a neutral and preferable color tone as a black ink. Further, the values of a* and b* can be measured using, for example, a spectrophotometer (trade name: Spectrolino; manufactured by Gretag Macbeth), but the method for measuring the a* and b* values in the present disclosure is not limited to the method above.

Furthermore, in the present disclosure, the ink composition having a color tone which is neutral on any one of recording mediums including an ink jet recording medium such as glossy paper and coat paper (recording medium in which a color material such as a dye, a pigment, and the like is adsorbed on fine particles forming a porous structure of an ink-receiving layer) and plain paper, and is preferable as a black ink, indicates a black ink composition having excellent recording medium selectivity. Specifically, first, from the obtained values of L*, a*, and b* in the same way as above, when printing is performed on a recording medium having values of L*, a*, and b* of the unprinted part with a recording duty of 0% satisfying 90≦L*, −10≦a≦10, and −10≦b*≦10, it is examined whether an image having a recording duty of 100% satisfies a condition of 0≦L*≦40, and whether all the images having a recording duty of 10% to 100% satisfy a condition of −15≦a≦15 and −15≦b*≦15. As a result, in the present disclosure, the ink composition which is demonstrated to satisfy the above-described condition indicates an ink composition having excellent recording medium selectivity.

### 2. Ink Jet Ink Composition According to Suitable Embodiment of the Disclosure

As a result of the investigation as described above, it was found that it is suitable to suitably use a bisazo compound (dye) having the structure of the general formula (I) and a tetraazo compound (dye) the structure of the general formula (III) in combination as the color materials in order to provide high fastness, inhibition of a bronzing phenomenon, and a color developing property suitable as black. Further, it was also found that it is suitable to use an acetylene glycol-based surfactant to an ink composition in which the two dyes above are used in combination in order to control the penetration rate of the ink. In addition, the present inventors have found that by further adding a trisazo compound (dye) having the structure of the general formula (II) to an ink composition containing the two dyes above and the surfactant, an ink composition which has excellent intermittent discharging stability of the ink while not interfering with sufficient permeability into a recording medium, in addition to the above-described characteristics, can be obtained.

The present disclosure has been made on the basis of the related findings and its main characteristics includes the combined use of a specific bisazo-based dye, a specific trisazo dye, a specific tetraazo dye, and an acetylene glycol-based surfactant. Hereinbelow, the components constituting the ink jet ink composition according to a suitable embodiment of the present disclosure (hereinafter simply also referred to as the “ink composition” in some cases) and the physical properties or the like of the ink composition will be described in detail.

[2.1. First Color Material]

First, the bisazo compound represented by the general formula (I) which is used as a first color material in the ink composition according to the present embodiment is described. It is necessary that the ink composition according to the present embodiment contain a bisazo compound represented by the following general formula (I) as a first color material for the purpose of improving the fastness of an image.

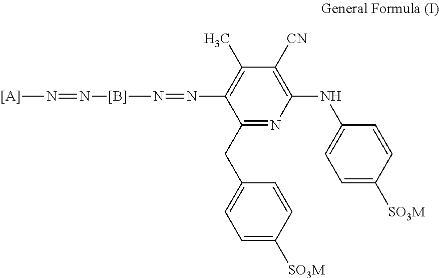

In the general formula (I), [A] is a group represented by any one of the following general formulae (1) to (4), [B] is a group represented by any one of the following general formulae (5) to (9), and each M is independently a hydrogen atom, an alkali metal, ammonium (NH₄⁺), or organic ammonium (for example, ammonium, such as primary to quaternary ammonium and the like, having a hydrogen atom being substituted with an organic group such as an alkyl group, an aryl group, and the like; this shall apply hereinafter).

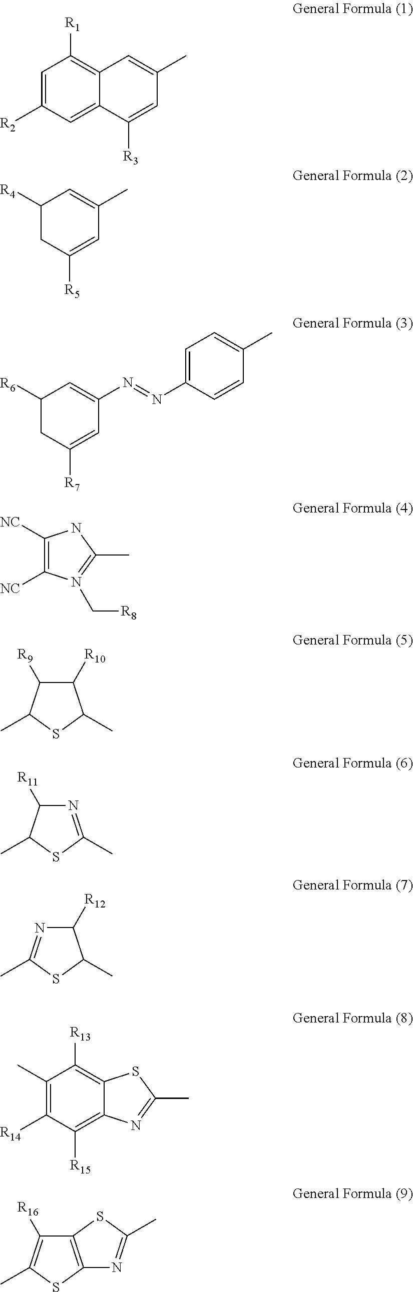

In the general formulae (1) to (9), R₁ to R₁₆ are each independently a hydrogen atom, a halogen atom, an aliphatic group, an aromatic group, a heterocyclic group, a carboxyl group, a carbamoyl group, an alkoxycarbonyl group, an aryloxycarbonyl group, a heterocyclic oxycarbonyl group, an acyl group, a hydroxyl group, an alkoxy group, an aryloxy group, a heterocyclic oxy group, a silyloxy group, an acyloxy group, a carbamoyloxy group, an alkoxycarbonyloxy group, an aryloxycarbonyloxy group, an aniline group, an amino group including a heterocyclic amino group, an acylamino group, a ureido group, a sulfamoylamino group, an alkoxycarbonylamino group, an aryloxycarbonylamino group, an alkylsulfonylamino group, an arylsulfonylamino group, a heterocyclic sulfonylamino group, a cyano group, a nitro group, an alkylthio group, an arylthio group, a heterocyclic thio group, an alkylsulfonyl group, an arylsulfonyl group, a heterocyclic sulfonyl group, an alkylsulfinyl group, an arylsulfinyl group, a heterocyclic sulfinyl group, a sulfamoyl group, or a sulfonic acid group, each of which may be further substituted.

Furthermore, in the compound represented by the general formula (I) of the first color material in the present embodiment, it is particularly preferable that [A] be a group of any one of the following general formula (12) or the general formula (13), and [B] is a group of any one of the following general formula (14) or the general formula (15).

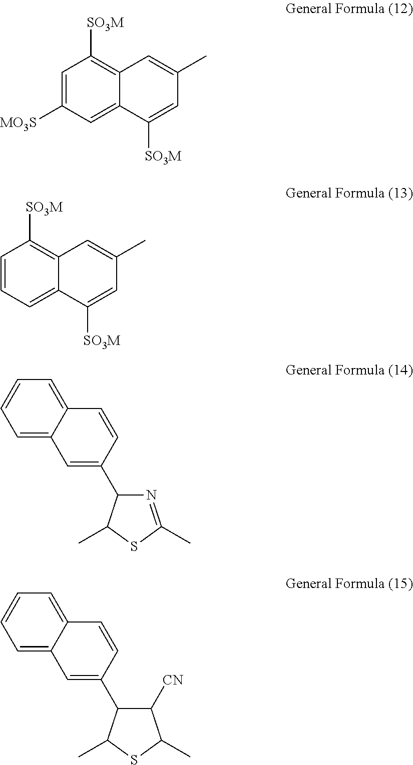

In the general formula (12) and the general formula (13), each M is independently a hydrogen atom, an alkali metal, ammonium, or organic ammonium.

Preferred specific examples of the compound represented by the general formula (I) include the following Exemplary Compounds 1 to 4. Of course, the first color material in the present embodiment is not limited to the following Exemplary Compounds 1 to 4 as long as it is the compound included by the general formula (I). However, it is particularly preferable to use the Exemplary Compound 1, among the following Exemplary Compounds, as the first color material in the present embodiment, from the viewpoint that it has excellent image fastness and an excellent color developing property, and has excellent basic characteristics as a black dye, such as high solubility in water and the like.

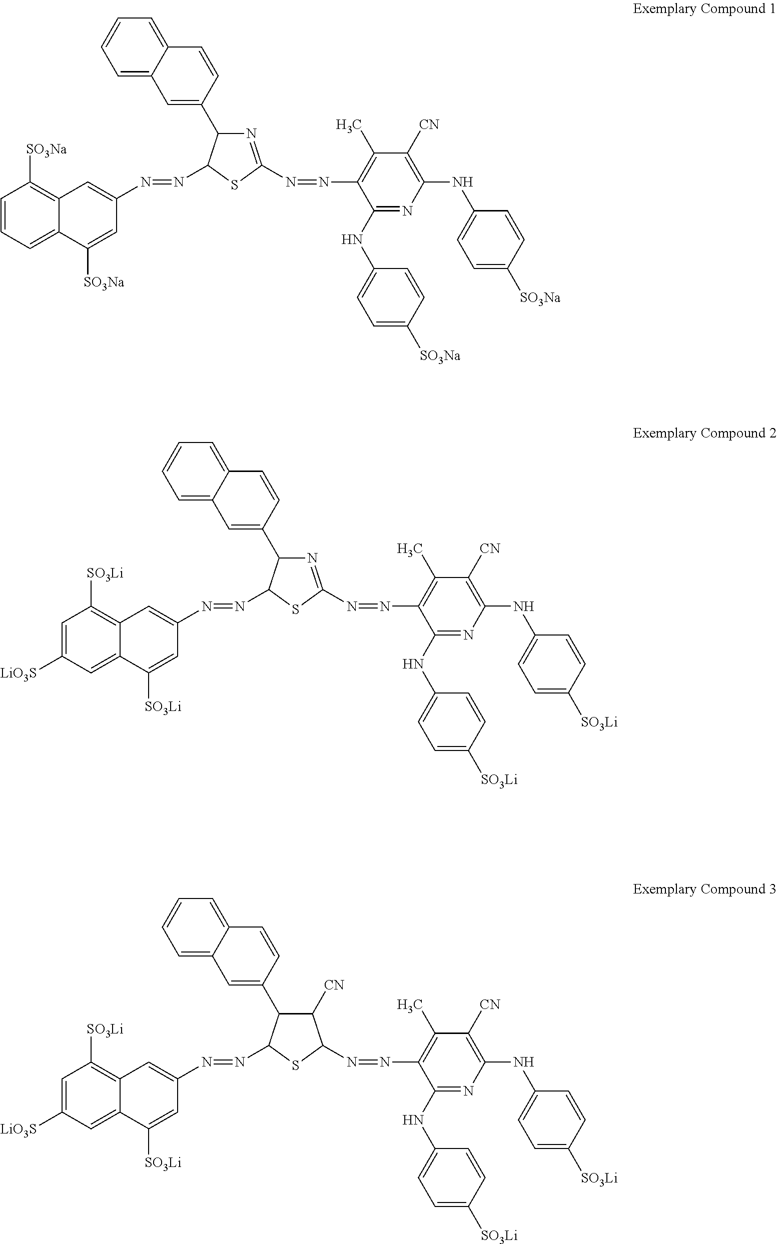

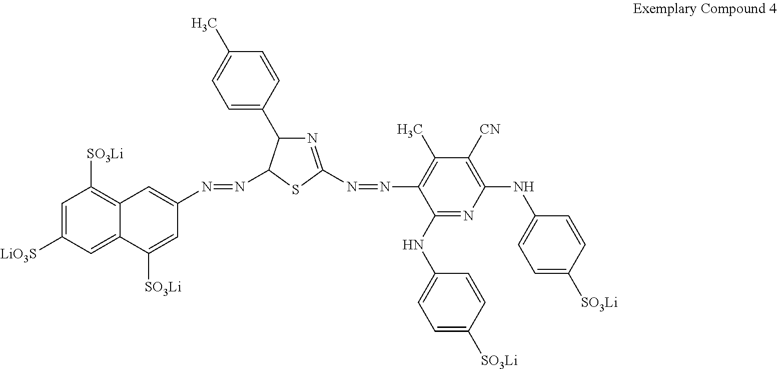

[2.2. Second Color Material]

Next, the trisazo compound represented by the general formula (II) as a second color material in the ink composition according to the present embodiment will be described. As described above, if the compound of the general formula (I) and the acetylene glycol-based surfactant represented by the general formula (IV), each having excellent fastness of an image, are used in combination, there is a problem that a function to lower the surface tension of the surfactant is not sufficiently exerted. Therefore, for the purpose of solving the problems, it is necessary for the ink composition according to the present embodiment to contain the following the trisazo compound represented by the general formula (II) as a second color material.

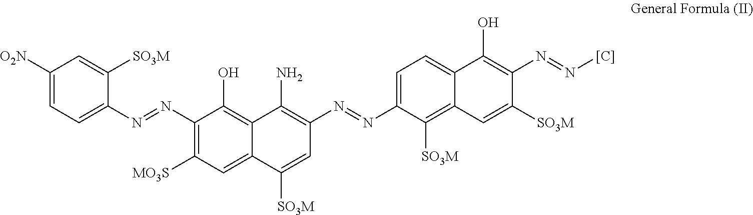

In the general formula (II), [C] is a phenyl group or a naphthyl group. The phenyl group and the naphthyl group may be substituted with a halogen atom, a carboxyl group, a sulfo group, an alkyl group, a phenyl group, a sulfamoyl group, or a nitro group. Further, each M is independently a hydrogen atom, an alkali metal, ammonium, or organic ammonium.

Here, the present inventors have assumed that the reason why a function of the surfactant is not exerted is that the structure of the compound of the general formula (I) used as a color material having excellent fastness inhibits the surface-active performance of the surfactant of the general formula (IV), but the mechanism is not clearly figured out. However, as a result of investigation by the present inventors, it was proved that the addition of the compound represented by the general formula (II) as a second color material to the ink composition can sufficiently lower the surface tension while not increasing the amount of the surfactant to be added.

Furthermore, it is particularly preferable to use the compound of the general formula (V), among the compounds represented by the general formula (II), as a second color material in the present embodiment.

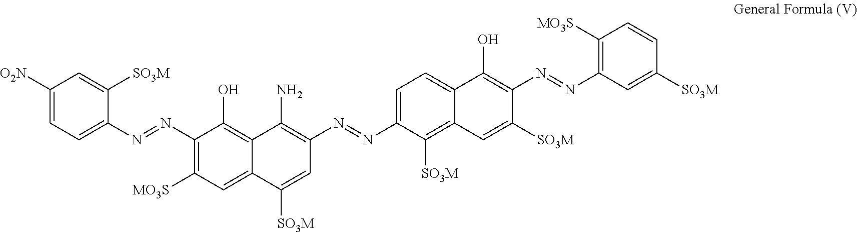

In the general formula (V), each M is independently a hydrogen atom, an alkali metal, ammonium, or organic ammonium.

Preferred specific examples of the compound represented by the general formula (II) include the following Exemplary Compounds 5 to 7. Of course, the second color material in the present embodiment is not limited to the following Exemplary Compounds 5 to 7 as long as it is a compound encompassed by the general formula (II). However, it is particularly preferable to use the Exemplary Compound 5, among the following Exemplary Compounds, as the second color material in the present embodiment, from the viewpoint that it can solve the problems concerning the findings of the function of the surfactant as described above and it has excellent image fastness or color developing property.

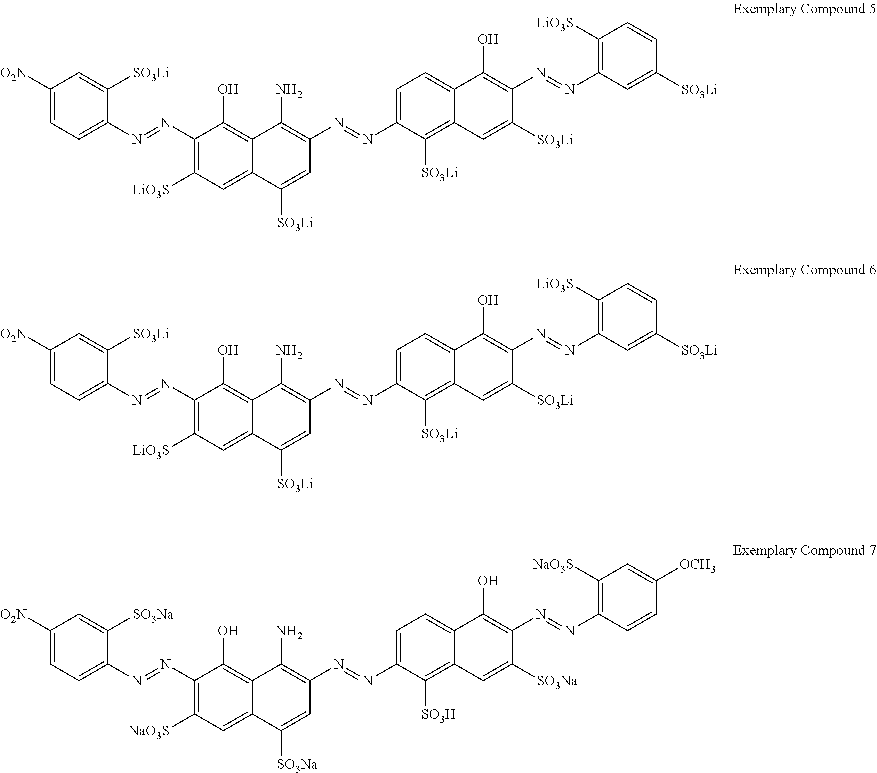

[2.3. Third Color Material]

Next, in the ink composition according to the present embodiment, the tetraazo compound represented by the general formula (III), which is used as a third color material, will be described. The ink composition according to the present embodiment has good color as a black ink and excellent fastness, and also, for the purpose of inhibition of gloss bronzing, it is necessary to include a tetraazo compound represented by the following general formula (III) as a third color material.

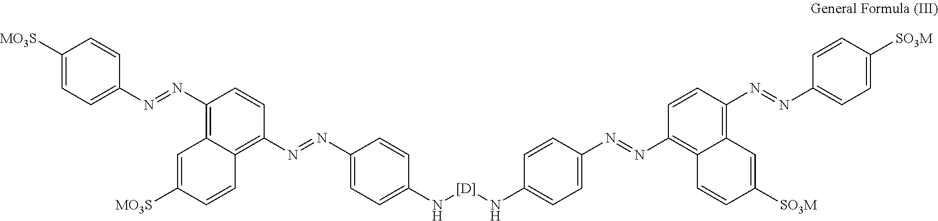

In the general formula (III), the bridge [D] has the following general formula (10) or (11), and each M is independently a hydrogen atom, an alkali metal, ammonium, or organic ammonium.

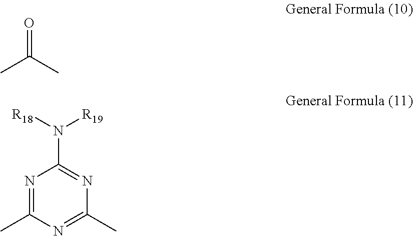

Here, in the general formula (11), R₁₂ and R₁₉ are each independently a hydrogen atom or a monovalent substituent. Further, specific examples of the “monovalent substituent” in the general formula (11) include a sulfone group, an alkyl group, an aryl group, a cyano group, an alkoxy group, an amide group, a ureido group, a sulfonamide group, a carbamoyl group, a sulfamoyl group, an alkoxycarbonyl group, a carboxylic group, and the like. Further, these groups may each have each a substituent.

Preferred specific examples of the compound represented by the general formula (III) include the following Exemplary Compounds 8 and 9. Of course, the third color material in the present embodiment is not limited to the following Exemplary Compounds 8 and 9 as long as it is the compound included by the general formula (III).

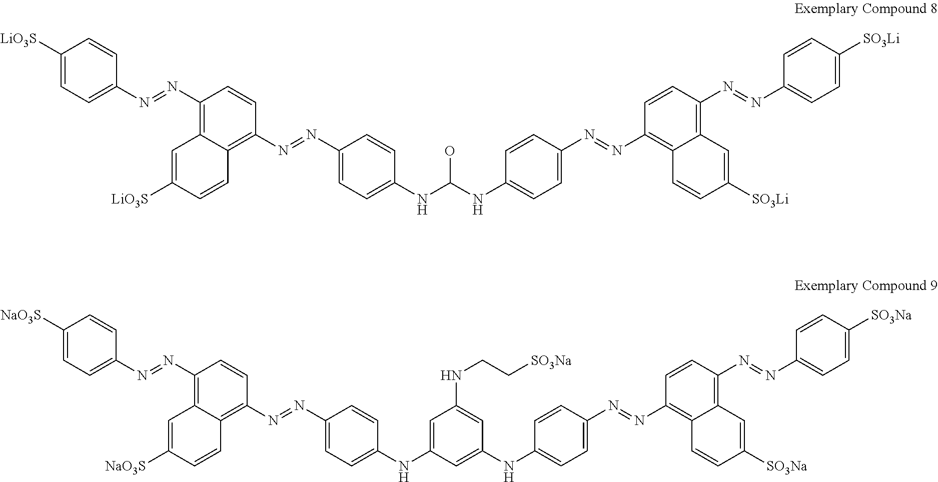

[2.4. Surfactant]

Next, the ethylene oxide adduct of acetylene glycol represented by the general formula (IV) which is used as a surfactant in the ink composition according to the present embodiment will be described. It is necessary for the ink composition according to the present embodiment to contain an ethylene oxide adduct of acetylene glycol represented by the following general formula (IV) as a surfactant for the purpose of controlling the penetration rate of the ink composition into a recording medium, improving the color bleeding property, and obtaining a high-quality image.

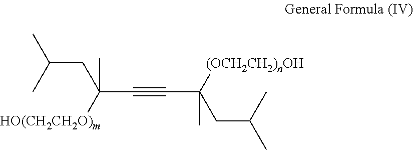

In the general formula (IV), m and n are an integer of 1 or more.

Here, it is important that the ink composition according to the present embodiment contain the ethylene oxide adduct of acetylene glycol represented by the general formula (IV) (acetylene glycol-based surfactant) in an amount of 0.10% by mass or more and less than 0.80% by mass, based on the total amount of the ink composition. Thus, by setting the content of the acetylene glycol-based surfactant to 0.10% by weight or more, sufficient permeability into a recording medium can be obtained. Further, by setting the content of the acetylene glycol-based surfactant to less than 0.80% by mass, generation of blurring (bleed) of an image is prevented, and further, the intermittent discharging stability is excellent, a printing pause time acceptable for obtaining a good image can be increased, and a maintenance load can be reduced. From the viewpoint of improving the effect, the content of the acetylene glycol-based surfactant of the general formula (IV) is preferably 0.3% by mass or more and 0.5% by mass or less.

As the ethylene oxide adduct of acetylene glycol represented by the general formula (IV), commercially available products such as Surfynol 465, Surfynol 485, and Olfine E1010 manufactured by Nissin Chemical Industry Co., Ltd., Acetylenol E100 manufactured by Kawaken Fine Chemicals Co., Ltd., and the like can be used. Of course, the surfactant in the present embodiment is not limited to the products as long as it is a compound encompassed by the general formula (IV).

Moreover, in the present embodiment, from the viewpoint of further improving the color bleeding property and obtaining a higher-quality image, the HLB (Hydrophile-Lipophile Balance) value of the surfactant represented by the general formula (IV) is particularly preferably 10 or more.

[2.5. Content of Color Material]

With the ink composition according to the present embodiment, the total content of the first color material represented by the general formula (I), the second color material represented by the general formula (II), and the third color material represented by the general formula (III) (hereinafter sometimes described as the “total amount of the color materials”) is preferably 3.00% by mass or more and 6.00% by mass or less, based on the total mass of the ink composition.

If the total amount of the color materials is less than 3.00% by mass, the density of the printed matter is not be sufficiently obtained in some cases. Further, if the total amount of the color materials is more than 6.00% by mass, the intermittent discharging stability of the ink composition drops in some cases. In addition, it could be seen that by setting the total amount of the color materials to the above-described range, even when the ink jet ink composition according to the present embodiment, having a content (% by mass) of the acetylene glycol-based surfactant represented by the general formula (IV) of 0.10% by mass or more and less than 0.80% by mass, is applied to a thermal ink jet recording system, in which ink is discharged by applying thermal energy, the ink is provided with excellent durability for the heater (heating element) of the recording head.

[2.6. Content Ratio of Color Material]

Furthermore, with the ink composition according to the present embodiment, the content ratio of each color material is preferably as follows. First, the mass ratio of the content (% by mass) of the first color material represented by the general formula (I) to the content (% by mass) of the second color material represented by the general formula (II) is preferably 0.50 times or more and 6.00 times or less, based on the total mass of the ink composition. Second, the mass ratio of the total content (% by mass) of the first color material represented by the general formula (I) and of the second color material represented by the general formula (II) to the content (% by mass) of the third color material represented by the general formula (III) is preferably 4.00 times or more and 6.00 times or less, based on the total mass of the ink composition.

By setting the content ratio of the first color material to the second color material to the above-described range, the surface-active performance of the acetylene glycol-based surfactant represented by the general formula (IV) can be sufficiently maintained, and further, an ink composition which is capable of realizing excellent light resistance and giving an image of a color tone particularly preferable as a black ink can be provided.

[2.7. Method for Characterization of Color Material]

The compounds (color materials) of the general formulae (I) and (II) may be identified by, for example, High Performance Liquid Chromatography (HPLC), Fourier Transform Infrared Spectral Photometer (FT-IR), and Nuclear Magnetic Resonance (NMR) methods, or mass spectrometry such as Fast Atom Bombardment Mass Spectrometer (FABMS), Pyrolysis Gas Chromatography Mass Spectrometry (PyGC/MS), Liquid Chromatography Mass Spectrometry (LC/MS), and the like.

[2.8. Solvent]

In the ink composition according to the present embodiment, water or a mixed solvent of water and a water-soluble organic solvent can be used as a solvent (aqueous medium).

As water, deionized water (ion exchange water) is preferably used. The content (% by mass) of water in the ink composition is preferably 60.0% by mass or more and 90.0% by mass or less, and more preferably 70.0% by mass or more and 90.0% by mass or less, based on the total mass of the ink composition.

The water-soluble organic solvent is not particularly limited as long as it is water-soluble, and as such a solvent, an alcohol, a polyhydric alcohol, a polyglycol, a glycol ether, and other polar solvents can be used. Specific examples of the water-soluble organic solvent include alkyl alcohols each having 1 to 4 carbon atoms, such as methyl alcohol, ethyl alcohol, n-propyl alcohol, isopropyl alcohol, n-butyl alcohol, sec-butyl alcohol, tert-butyl alcohol, and the like; amides such as dimethylformamide, dimethylacetamide, and the like; ketones or keto alcohols such as acetone, diacetone alcohol, and the like; ethers such as tetrahydrofuran, dioxane, and the like; polyalkylene glycols such as polyethylene glycol, polypropylene glycol, and the like; glycols such as ethylene glycol, propylene glycol, butylene glycol, diethylene glycol, triethylene glycol, hexylene glycol, thiodiglycol, and the like; alkylene glycols in which alkylene groups have 2 to 6 carbon atoms, such as 1,5-pentanediol, 1,6-hexanediol, 2-methyl-1,3-propanediol, 3-methyl-1,5-pentanediol, 1,2,6-hexanetriol, and the like; bis(2-hydroxyethyl)sulfone; lower alkyl ether acetates such as polyethylene glycol monomethyl ether acetate and the like; polyhydric alcohol alkyl ethers such as ethylene glycol monomethyl (or -ethyl)ether, diethylene glycol methyl (or -ethyl)ether, triethylene glycol monomethyl (or -ethyl)ether, and the like; N-methyl-2-pyrrolidone; 2-pyrrolidone; 1,3-dimethyl-2-imidazolidinone; and the like. These water-soluble organic solvents can be used singly or as a mixture of two or more kinds thereof, as necessary. Of course, the water-soluble organic solvent in the present embodiment is not limited to the specific examples above.

Moreover, the content (% by mass) of the water-soluble organic solvent in the ink composition is preferably 5.0% by mass or more and 30.0% by mass or less, and more preferably 10.0% by mass or more and 30.0% by mass or less, based on the total mass of the ink composition. If the content of water is less or more than the range, that is, the content of the water-soluble organic solvent is out of the range, reliability such as intermittent discharging stability and the like are not typically obtained in the case of using the ink composition in an ink jet recording apparatus.

Furthermore, in the ink composition according to the present embodiment, 1,2-alkylene glycol in which an alkylene group has 5 to 7 carbon atoms may further contain at least one diol selected from the group consisting of 1,2-pentanediol, 1,2-hexanediol, and 1,2-octanediol in an amount of 1.0% by mass or more and less than 4.0% by mass, based on the total mass of the ink composition.

[2.9. Other Additives]

With the ink composition according to the present embodiment, additives such as various defoaming agents, pH adjusters, fungicides, and the like may be added to the solvent.

The defoaming agent is used in order to prevent the ink composition from bubbling, and specific examples of the defoaming agent include organic defoaming agents such as silicon-based defoaming agents, surfactants, polyethers, higher alcohols, and the like. Further, in the case where the surfactant is used as a defoaming agent, a polyglycol-based non-ionic surfactant (commercially available products thereof include Antifroth F233 manufactured by Dai-ichi Kogyo Seiyaku Co., Ltd.) is preferably used.

As the pH adjuster, sodium salts, potassium salts, amines, or the like can be used. Examples of the sodium salts and the potassium salts include sodium hydroxide, potassium hydroxide, lithium hydroxide, sodium carbonate, sodium bicarbonate, potassium carbonate, lithium carbonate, sodium phosphate, potassium phosphate, lithium phosphate, potassium dihydrogen phosphate, dipotassium hydrogen phosphate, sodium oxalate, potassium oxalate, lithium oxalate, sodium borate, sodium tetraborate, potassium hydrogen phthalate, potassium hydrogen phthalate, and the like. Further, as the amines, ammonia, methylamine, ethylamine, diethylamine, tris(hydroxymethyl)aminomethane hydrochloride, triethanolamine, morpholine derivatives, propanolamine, and the like are preferably used. The same pH adjuster as above contributes to the dissolution stability or permeability of the colorant in the ink composition, while giving an effect on deterioration of the heating element (heater) of a thermal print head. From such a viewpoint, the content of the pH adjuster is preferably 0.10% by mass or more and less than 0.50% by mass, based on the total mass of the ink composition. If the content of the pH adjuster is less than 0.10% by mass, the pH is not appropriately controlled in some cases. Further, a content of the pH adjuster of 0.50% by mass or more accelerates the deterioration of the heater or gives an adverse effect on the intermittent discharging stability in some cases. Further, taking into consideration of stability, in addition to the purpose of improvement of the dissolution stability or the permeability of the colorant, it is preferable that the pH adjuster be added to adjust the pH of the ink composition in the range of 6.0 to 9.0.

Furthermore, in the present embodiment, among the various pH adjusters as described above, 3-morpholinopropane sulfonic acid (MOPS) which is a morpholine derivative is particularly preferably used. By using MOPS, cogation of the heating element does not easily occur and the lifespan of the heating element can be increased.

As the fungicide, for example, organic nitrogen/sulfur-based compounds such as thiabendazole, cyabendazole, and the like can be used, in addition to sodium benzoate, potassium sorbitrate, and benzoimidazole.

Furthermore, as a constituting component of the ink composition according to the present embodiment, alcoholamines such as monotriethanolamine, ditriethanolamine, and the like, and amides such as dimethylformamide, dimethylketoneamide, and the like can be suitably used. These alcoholamines, amides, or the like are used to obtain a pH adjusting effect or a moisturizing effect.

Moreover, the ink composition according to the present embodiment can include at least one humectant selected from water-soluble organic solvents having a lower vapor pressure than purified water, and sugars. As the humectant, for example, trimethylolpropane, urea, or the like can be used, in addition to xylitol. By incorporating the humectant into, the ink composition, when the ink composition according to the present embodiment is used in the ink jet recording method, evaporation of the moisture can be suppressed so as to moisturize the ink. Further, if the water-soluble organic solvent is used as a humectant, the discharging stability can be improved or the viscosity of the ink composition can be modified while not changing the characteristics of the ink.

[2.10. Method for Preparing Ink Composition]

The above-described inkjet ink composition according to the present embodiment can be prepared as follows. First, the first color material represented by the general formula (I), the second color material represented by the general formula (II), the acetylene glycol-based surfactant represented by the general formula (III), and other additives are weighed to predetermined concentrations and added to a solvent. Here, it is preferable to control the contents or content ratios of the color materials to the above-described ranges.

Next, by sufficiently stirring a solution obtained by adding the color materials, the surfactants, and the like to a solvent, and then filtering it through a PTFE membrane-disc filter having a pore diameter of 0.45 μm, the ink jet ink composition according to the present embodiment can be obtained.

### 3. Ink Jet Recording Method According to Suitable Embodiment of the Disclosure

The ink jet recording method according to a suitable embodiment of the present disclosure is a method in which liquid droplets of the ink composition are discharged by an ink jet system to perform recording on a recording medium. The ink jet recording method according to the present embodiment may be one of a continuous ejection type or an on-demand type. The continuous ejection type is a general term for types in which ink droplets are continuously ejected from a recording head, irrespective of the control signal (also referred to as a “dot formation signal” or a “recording signal”), and only the ink droplets used for recording reach the recording medium. The on-demand type is a general term for types in which ink droplets are discharged from a recording head to a recording medium according to the control signal.

Furthermore, examples of the on-demand type of the ink jet recording method include a recording method involving applying mechanical energy to ink to discharge the ink droplets, a recording method involving applying thermal energy to ink to discharge the ink droplets, and the like. Examples of the recording method involving applying mechanical energy to ink include a piezo ink jet system in which ink droplets are discharged using a reverse piezoelectric effect of a piezoelectric body typified by PZT (lead zirconate titanate), an electrostatic suction system in which electrically charged ink is sucked onto a recording medium with an electrostatic force, and the like. It is particularly preferable to use an ink jet recording method using thermal energy (thermal ink jet system), as the ink jet recording method according to the present embodiment.

[3.1. Usable Ink]

In the ink jet recording method according to the present embodiment, the ink jet ink composition according to a suitable embodiment of the present disclosure as described above is used as an ink composition.

[3.2. Usable Recording Medium]

In the ink jet recording method according to the present embodiment, any recording medium on which recording is performed by applying the ink thereto can be used as (a) recording medium (media) used for formation of an image. In the present embodiment, it is preferable to use an ink jet recording medium in which color materials such as a dye, a pigment, and the like are adsorbed on fine particles which form a porous structure of an ink-receiving layer. It is particularly preferable to use a recording medium having a so-called gap absorption type ink-receiving layer, which absorbs ink by a gap formed in the ink-receiving layer on the support. The gap absorption type ink-receiving layer is mainly composed of a fine particle and may further contain a binder and any other additive, as necessary.

As the fine particles mainly composing the gap absorption type ink-receiving layer, specifically, an inorganic pigment or an organic pigment can be used. Examples of the inorganic pigment include silica, clay, talc, calcium carbonate, kaolin, aluminum oxide such as alumina, alumina hydrate, and the like, diatomaceous earth, titanium oxide, hydrotalcite, zinc oxide, and the like. Examples of the organic pigment include a urea formalin resin, an ethylene resin, a styrene resin, and the like. These fine particles can be used singly or in combination of two or more kinds thereof, as necessary.

In particular, when an image is formed using the ink composition according to the present embodiment, it is preferable to use a recording medium having formed thereon an ink-receiving layer mainly composed of fine particles having an average particle diameter of 1 μm or less. Specific examples of the fine particles include silica fine particles typified by colloidal silica, aluminum oxide fine particles, alumina hydrate fine particles (alumina-based pigments), and the like.

Among the above alumina-based pigments, alumina hydrate such as pseudoboehmite represented by the following formula, and the like can be particularly mentioned as a suitable one:

AlO₂₋ₙ(OH)₂ₙ.mH₂O

(wherein n is an integer of 1 to 3, and m is 0 to 10, and preferably 0 to 5, provided that m and n are not simultaneously 0).

In many cases, mH₂O also represents an eliminable aqueous phase which does not participate in the formation of mH₂O crystal lattices. For this reason, m may take one of an integer and a value which is not an integer. Further, when this type of alumina hydrate is heated, m may reach 0. The alumina hydrate can be prepared by an existing method as follows. For example, it can be prepared by hydrolysis of aluminum alkoxide and sodium aluminate as described in U.S. Pat. No. 4,242,271 and U.S. Pat. No. 4,202,870. In addition, it can be prepared by a method in which an aqueous solution of one of sodium sulfate and aluminum chloride is added to an aqueous solution of sodium aluminate to effect neutralization as described in Japanese Examined Patent Application Publication No. 57-044605.

As the binder included in the gap absorption type ink-receiving layer, a water-soluble polymer, a latex, or the like can be used. Examples of the water-soluble polymer, the latex, and the like include polyvinyl alcohol, starch, gelatin, or modified products thereof; gum arabic; cellulose derivatives such as carboxymethyl cellulose, hydroxyethyl cellulose, hydroxyproylmethyl cellulose, and the like; vinyl-based copolymer latexes such as an SER latex, an NBR latex, a methyl methacrylate-butadiene copolymer latex, a functional group-modified polymer latex, an ethylene-vinyl acetate copolymer, and the like; polyvinyl pyrrolidone; maleic anhydride or a copolymer thereof; an acrylic ester copolymer; and the like. These binders can be used singly or in combination of two or more kinds thereof, as necessary.

As the other additive included in the gap absorption type ink-receiving layer, for example, a dispersant, a thickener, a pH adjuster, a lubricant, a fluidity denaturing agent, a surfactant, a defoaming agent, a releasing agent, a fluorescent brightener, an ultraviolet ray absorber, an antioxidant, a dye fixing agent, or the like can be used.

The recording medium used in the ink jet recording method according to the present embodiment preferably has a support for supporting the above-described ink-receiving layer. Any support can be used without any particular limitation as long as its ink-receiving layer can be formed of the above-described porous fine particles and the support provides rigidity such that the support can be transported by a transport system of an ink jet printer or the like. Specific examples thereof include a paper support formed of a pulp raw material mainly composed of natural cellulose fibers; a plastic support composed of a material such as polyesters (for example, polyethylene terephthalate), cellulose triacetate, polycarbonate, polyvinyl chloride, polypropylene, polyimide, and the like; and resin-coated paper (for example, RC paper) having, on at least one side of a base paper, a polyolefin resin-coated layer with an added white pigment or the like.

Furthermore, in the present embodiment, the pH of the surface of the recording medium is preferably 3.0 or more and 8.0 or less. Further, in order to sufficiently obtain an effect in the case where the ink composition according to the present embodiment is used, that is, an effect of obtaining an image having excellent fastness with a high image quality, and the like, the pH of the surface of the recording medium is particularly preferably 4.0 or more and 6.0 or less.

### 4. Ink Cartridge According to Suitable Embodiment of the Disclosure

The ink cartridge according to a suitable embodiment of the present disclosure include an ink-storing unit for storing ink, and uses the ink jet ink composition according to the present embodiment as described above as the ink. In the ink-storing unit, an ink-storing unit for storing each ink of yellow, magenta, and cyan may be further provided, in addition to storing the ink composition (black ink) according to the present embodiment. Further, specific examples of the ink cartridge will be described later.

### 5. Recording Unit According to Suitable Embodiment of the Disclosure

The recording unit according to a suitable embodiment of the present disclosure includes an ink-storing unit for storing ink and a recording head for discharging the ink stored in the ink-storing unit, in which the above-described ink jet ink composition according to the present embodiment is used as the ink. In particular, with the suitable recording head which is suitable for performing recording using the ink composition according to the present embodiment, a thermal ink jet type recording unit in which ink droplets are discharged by applying thermal energy corresponding to a control signal to the ink can be used. Among these recording units, in the present embodiment, it is particularly preferable to use a recording head having a wetted surface of a heating unit containing at least one of a metal and a metal oxide. Examples of the metal or metal oxide constituting the wetted surface of a heating unit include metals such as Ta, Zr, Ti, Ni, Al, and the like, or oxides of the metals, and the like. Further, specific examples of the recording unit will be described later.

### 6. Ink jet Recording Apparatus According to Suitable Embodiment of the Disclosure

[6.1. Overview of Ink Jet Recording Apparatus]

The ink jet recording apparatus according to a suitable embodiment of the present disclosure includes an ink-storing unit for storing ink and a recording head for discharging the ink stored in the ink-storing unit, and uses the above-described ink jet ink composition according to the present embodiment as the ink. The ink jet recording apparatus according to the present embodiment has a system for supplying and delivering the recording medium, a system for transporting the recording medium, a system for maintaining the maintenance of the recording head, and the like, in addition to a recording unit including an ink-storing unit and a recording head.

In particular, an ink jet recording apparatus suitable for performing recording using the ink composition according to the present embodiment is a thermal ink jet type of an ink jet recording apparatus which discharges ink droplets by applying thermal energy corresponding to a control signal to the ink.

[6.2. Specific Constitution Examples of Ink Jet Recording Apparatus]

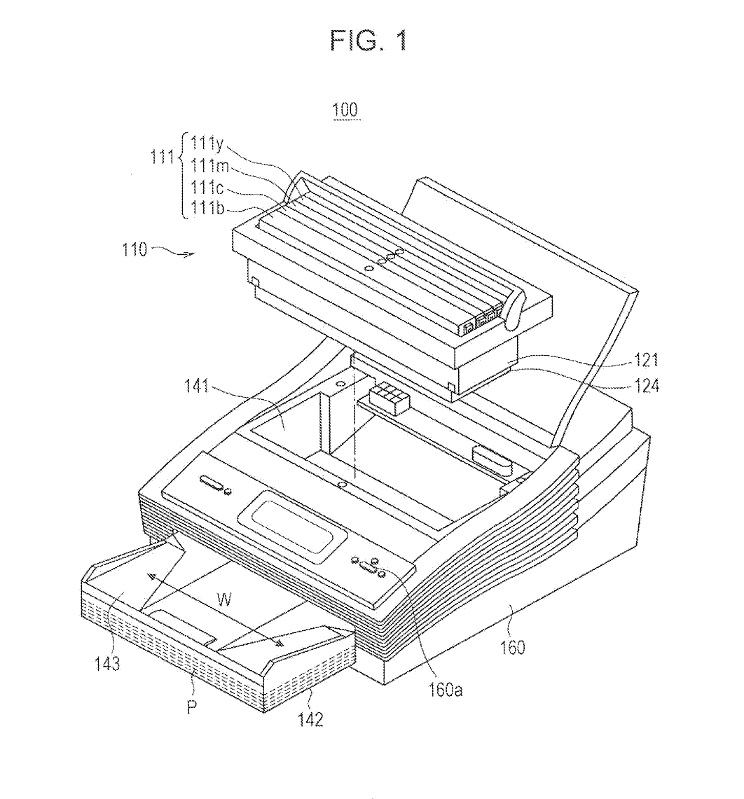

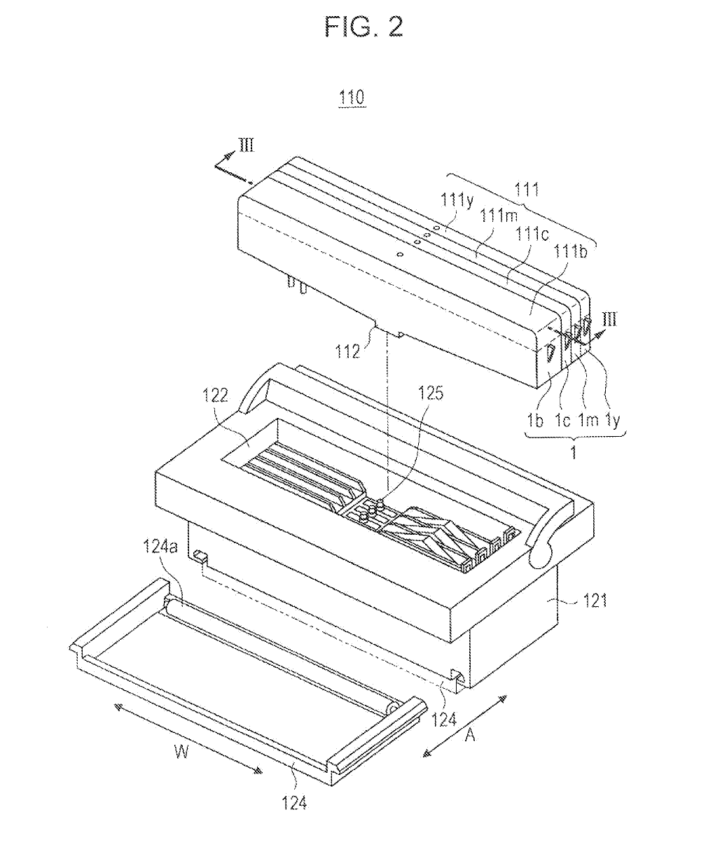

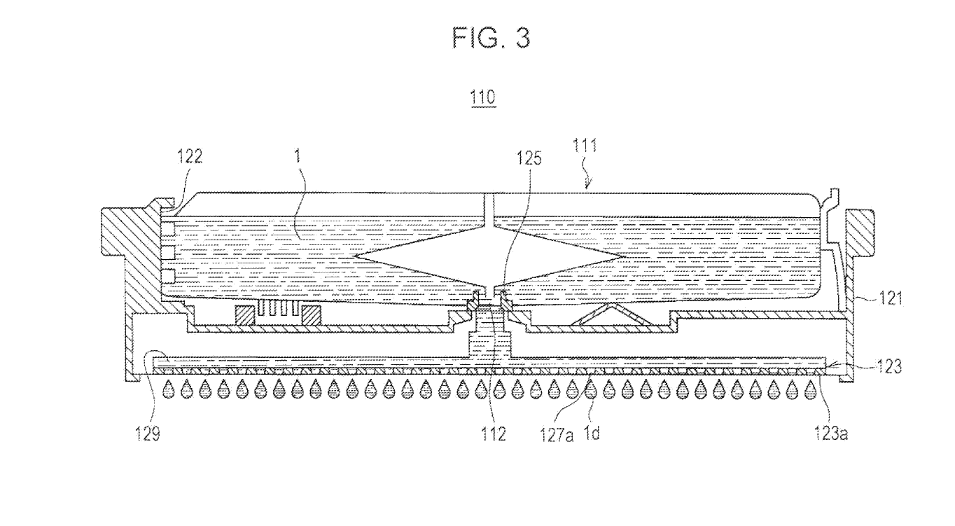

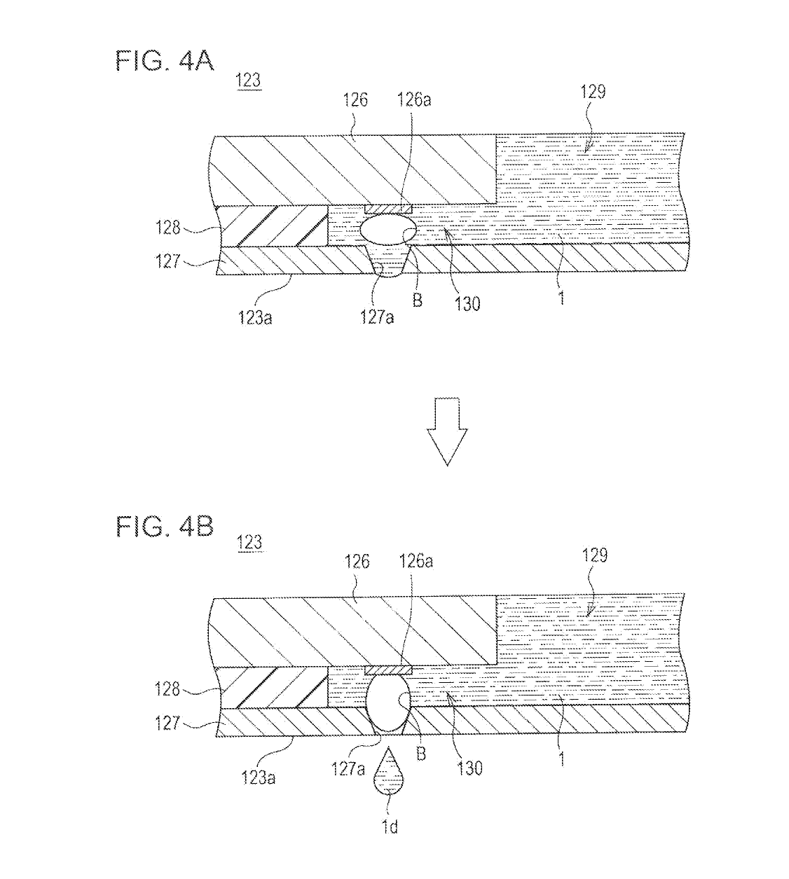

Here, with reference to FIGS. 1 to 4, a specific constitution of the ink jet recording apparatus according to the present embodiment will be described, citing a line type of an ink jet recording apparatus 100 having a recording head (line head) in which a plurality of nozzles is arranged substantially linearly along the width direction of the recording medium, as one example of the ink jet recording apparatus according to the present embodiment. Further, FIG. 1 is an exploded perspective view showing an example of the entire constitution of the ink jet recording apparatus according to a suitable embodiment of the present disclosure. FIG. 2 is an exploded perspective view showing an example of the constitution of the head cartridge provided in the ink jet recording apparatus 100 of FIG. 1. FIG. 3 is a cross-sectional view obtained by cutting the head cartridge shown in FIG. 2 along the III-III line. FIGS. 4A and 4B is a cross-sectional view showing the constitution of the recording head provided in the head cartridge shown in FIG. 3, in which (a) schematically shows the state of the bubbles generated on the heating element and (b) schematically shows the state of ink droplets discharged from the nozzle.

In the ink jet recording apparatus 100 shown in FIG. 1, the ink composition according to the present embodiment is used as a black ink 1b, and used in combination with a magenta ink 1m, a cyan ink 1c, and a yellow ink 1y, which have other colors, to form a color image or letter as recorded matter. Further, in the description below, the black ink 1b, the magenta ink 1m, the cyan ink 1c, and the yellow ink 1y are collectively referred to as an ink 1 simply in some cases.

As shown in FIG. 1, the ink jet recording apparatus 100 is a so-called line type of an ink jet recording apparatus, in which one or more rows of nozzles for discharging ink droplets in the width direction of the recording medium (for example, recording paper P), that is, in the direction of an arrow W in FIG. 1, are arranged substantially linearly. This ink jet recording apparatus 100 includes an ink jet printer head cartridge (hereinafter referred to as a “head cartridge”) 110 and an apparatus main body 160.

(6.2.1. Constitution of Head Cartridge)

The head cartridge 110 is detachably provided in the apparatus main body 160, and for example, in order to apply thermal energy corresponding to a control signal to the ink, the ink 1 is discharged using a heating resistor as a heating element and the ink 1 is landed onto the surface of the recording paper P. On the head cartridge 110, an ink cartridge 111 storing the ink 1 is mounted, as shown in FIGS. 2 and 3.

[Ink Cartridge]

The ink cartridge 111 includes four ink cartridges 111b, 111m, 111c, and 111y corresponding to the black ink 1b, the magenta ink 1m, the cyan ink 1c, and the yellow ink 1y, respectively. That is, the ink cartridge 111b includes an ink-storing unit storing the ink composition according to the present embodiment as the black ink 1b. In a similar way, the ink cartridges 111m, 111c, and 111y include ink-storing units storing the magenta ink 1m, the cyan ink 1c, and the yellow ink 1y, respectively. Further, the dimension in the length direction of the ink cartridge 111 is substantially the same as that in the width direction of the recording paper P, and the horizontal cross-section is formed to have a substantially rectangular shape. In addition, the ink cartridge 111 includes an ink supply unit 112 for supplying the ink 1 to the cartridge main body 121 of the head cartridge 110.

The ink supply unit 112 is provided at an approximate center part of the bottom surface of the ink cartridge 111. The ink supply unit 112 is a nozzle formed to protrude from the bottom surface of the ink cartridge 111, and by fitting the edge of the nozzle into the connection unit 125 of the head cartridge 110 described later, the ink cartridge 111 and the cartridge main body 121 of the head cartridge 110 are connected. Thus, the connection of the ink cartridge 111 with the cartridge main body 121 makes it possible to supply the ink 1 from the ink cartridge 111 to the cartridge main body 121. Further, in the ink supply unit 112, a valve system (not shown) for adjusting the amount of the ink 1 supplied from the ink cartridge 111 to the cartridge main body 121 is provided. Further, the ink cartridge 111 may be formed physically integrally with the cartridge main body 121.

[Cartridge Main Body]

The head cartridge 110 includes the cartridge main body 121 on which the ink cartridge 110 is mounted, in addition to the above-described ink cartridge 111. The cartridge main body 121 has a mounting unit 122 on which the ink cartridge 111 is mounted, a recording head 123 for discharging the liquid droplets of the ink 1 (hereinafter described as the “ink droplets 1d”), and a head cap 124 for protecting the recording head 123.

A connection unit 125, which is connected to the ink supply unit 112 of the ink cartridge 111 mounted on the mounting unit 122, is provided at an approximate center part in the length direction of the mounting unit 122. This connection unit 125 is an ink supply path for supplying the ink 1 from the ink supply unit 112 of the ink cartridge 111 mounted on the mounting unit 122 to the recording head 123 for discharging the ink droplets 1d provided on the bottom surface of the cartridge main body 121. In addition, in the connection unit 125, a valve system (not shown) for adjusting the amount of the ink 1 supplied from the ink cartridge 111 to the recording head 123 is provided.

The recording head 123 is provided on the bottom surface of the cartridge main body 121 and has a plurality of nozzles 127a (the details of which will be described later). A plurality of these nozzles 127a is discharging openings for discharging the liquid droplets of the ink 1 supplied from the connection unit 125, and is arranged substantially linearly in the width direction of the recording paper P, that is, in the direction of an arrow w in FIG. 3. Further, the nozzles 127a are provided, corresponding to each color of black, magenta, cyan, and yellow, and constitute a nozzle line of black, a nozzle line of magenta, a nozzle line of cyan, and a nozzle line of yellow. More, the nozzle lines of the respective colors are arranged to be aligned in the direction approximately perpendicular to the width direction of the recording paper P. The recording head 123 can discharge the ink droplets 1d in each nozzle line without moving in the width direction of the recording paper P when the ink droplets 1d are discharged, from the viewpoints of having the constitution as described above.

Furthermore, as shown in FIGS. 4A and 4B, in the recording head 123, a circuit substrate 126 provided with an electrothermal conversion type of heating resistors 126a and a plurality of nozzles 127a are formed. Further, in the recording head 123, a nozzle sheet 127 formed with a thin metal film such as a nickel-plated film and the like, and an ink flow path 129 for supplying the ink 1 supplied from the connection unit 125 to each of the nozzles 127a by a film 128 provided between the circuit substrate 126 and the nozzle sheet 127, are formed. This ink flow path 129 is formed such that the length direction is a direction in which the nozzles 127a are arranged, that is, a direction of an arrow W in FIG. 3. By this, in the recording head 123, the ink 1 flows from the ink cartridge 111 into the ink flow path 129 via the connection unit 125 of the head cartridge 110, and the ink 1 is supplied from the ink flow path 129 to each of the nozzles 127a. Further, in the recording head 123, an ink liquid chamber 130 surrounded with the circuit substrate 126, the nozzle sheet 127, and the film 128, in which the heating resistors 126a pressurizes the ink 1, is formed.

In the recording head 123 having the constitution as described above, a control signal generated based on the print data is transferred to the circuit substrate 126, and a pulsed electrical current is supplied for a predetermined time (for example, about 1 to 3 μsec) to the heating resistors 126a selected according to the control signal. In the recording head 123 to which the pulsed electrical current is supplied, the heating resistors 126a are driven and rapidly heated. At this time, in the recording head 123, when the heating resistors 126a are heated, bubbles B are generated in the ink 1 in contact with the heating resistors 126a, as shown in FIG. 4A. Next, in the recording head 123, bubbles B pressurize the ink 1 during expansion and the ink 1 pressurized by the bubbles B is brought into the state of liquid droplets and discharged from the nozzles 127a, as shown in FIG. 4B. Further, in the recording head 123, the ink droplets 1d are discharged, and the ink 1 is then supplied from the ink cartridge 111 to the ink liquid chamber 130 through the ink flow path 129 via a connection unit 125, thereby returning to the state before discharging. In the recording head 123, the above-described operations are repeated according to the control signal, and the ink droplets 1d are discharged on the recording paper P to form an image.

In the present embodiment, the head cartridge 110 has a head cap 124 for protecting the ink discharging surface 123a of the recording head 123. The head cap 124 obstructs the discharging surface 123a of the recording head 123 and protects the nozzle 127a from drying or the like, while the recording head 123 does not discharge the ink droplets 1d and does not carry out the recording operation, as shown in FIG. 2. When carrying out the recording operation, the head cap 124 moves from the bottom surface of the head cartridge 110 to the front surface side of the apparatus main body 160, and the discharging surface 123a is exposed to the outside and opened, as shown in FIG. 2. Further, in the head cap 124, a cleaning roller 124a for removing extra ink 1 attached on the discharging surface 123a is provided. In the head cap 124, when the discharging surface 123a is opened, the discharging surface 123a is cleaned by the cleaning roller 324a.

(6.2.2. Constitution of Apparatus Main Body)

The apparatus main body 160 has a head cartridge mounting unit 161, a paper feed tray 162, a paper delivery tray 163, a paper feed and delivery system (not shown), a head cap opening and closing system (not shown), as shown in FIG. 1. The head cartridge mounting unit 161 is provided on the top surface side of the apparatus main body 160, on which the head cartridge 110 is mounted. The paper feed tray 162 is provided on the lower side of the front surface of the apparatus main body 160, and the recording paper P before recording, such as an image and the like, is laminated and stored. The paper delivery tray 163 is provided on the upper side of the front surface of the apparatus main body 160, and the recording paper P after recording, such as an image and the like, is laminated and stored. Further, the paper feed and delivery system is a system for transporting the recording paper P in the apparatus main body 160, and the head cap opening and closing system is a system for opening and closing the head cap 124, that is, for moving the head cap 124 so as to open or close the discharging surface 123a of the recording head 123.

(6.2.3. Operation of Ink Jet Recording Apparatus)

The ink jet recording apparatus 100 having the constitution as described above generates a control signal for controlling the operation of the paper feed and delivery system, the head cap opening and closing system, and the recording head 123, according to the print data input from an information processing apparatus provided in the outside. This control signal is generated by a control unit provided in a control circuit which controls the supply of the electrical current to the paper feed and delivery system, the head cap opening and closing system, and the recording head 123. Further, by supplying the electrical current controlled by a control signal to the paper feed and delivery system, the head cap opening and closing system, and the recording head 123, the operations such as the paper feed and delivery of the recording paper P, opening and closing of the head cap 124, and discharging of the ink droplets 1d by the recording head 123, and the like are carried out.

More specifically, in the ink jet recording apparatus 100, first, a print start is ordered of the control unit by the operation of an operation button 160a provided in the apparatus main body 160, the paper feed and delivery system and the head cap opening and closing system are driven by the control signal transferred to the driving control unit to become ready for printing. That is, the head cap opening and closing system moves the head cap 124 to the front surface side of the apparatus main body 160, which is a side having the paper feed tray 162 and the paper delivery tray 163 provided thereon, with respect to the head cartridge 110. This cause the nozzles 127a provided in the discharging opening 123a of the recording head 123 to be brought into an open state to be exposed to the outside, and thus, the recording head 123 can discharge the ink 1.

Next, the paper feed and delivery system takes out only one sheet of recording paper P from the paper feed tray 162 and transports the recording paper P to a position opposite to the discharging surface 123a of the recording head 123. Thus, the recording paper P becomes opposite to the discharging surface 123a.

Next, in the ink jet recording apparatus 100, the driving electrical current is supplied to the heating resistors 126a selected by a control signal according to the print data in a plurality of the heating resistors 126a provided in the recording head 123, and the selected heating resistors 126a are heated. In the ink jet recording apparatus 100, the ink droplets 1d are discharged by the nozzle 127a corresponding to the heated heating resistors 126a to the recording paper P transported to a position opposite to the discharging surface 123a, as shown in FIGS. 4A and 43, by heating the heating resistors 126a, thereby recording an image, a letter, or the like.

Next, in the paper feed and delivery system, the recording paper P in which recording of an image, a letter, or the like is completed is fed and transported to the paper delivery tray 163 and the recording paper P after recording is delivered to the paper delivery tray 163. Thus, in the ink jet recording apparatus 100, recording of an image, a letter, or the like is performed in the recording paper P. After recording, the head cap opening and closing system moves the head cap 124 waiting on the front surface side of the apparatus main body 160 to the bottom surface of the head cartridge 110, and obstructs and protects the discharging surface 123a of the recording head 123. In addition, at this time, the discharging surface 123a may be cleaned by the cleaning roller 124a.

### 7. Conclusion

As described above, the ink composition according to the present embodiment is intended to solve the problems occurring in the case of the combined use of the bisazo dye of the general formula (I), the tetraazo dye of the general formula (III), and the acetylene glycol-based surfactant of the general formula (IV). Specifically, by the addition of the trisazo dye of the general formula (II) to the ink composition including the dye and the surfactant, the surface-active performance can be sufficiently exerted while not increasing the content of the surfactant of the general formula (IV).

Therefore, according to the present embodiment, an ink jet ink composition, which is capable of recording recorded matter having excellent fastness with a high image quality and has excellent intermittent discharging stability. In particular, as for the intermittent discharging property, a good image can be obtained stably even during a printing pause time of 5 seconds or longer, and in a further preferable embodiment, 10 seconds or longer, as described in the Examples described later. Further, according to the present embodiment, an ink jet ink composition having a preferable color tone as a black ink can be obtained. In addition, the ink jet ink composition according to the present embodiment has excellent durability for a heating element (heater) even when used in a thermal ink jet recording system.

Moreover, by the ink jet recording method, the ink cartridge, the recording unit, and the ink jet recording apparatus according to the present embodiment, an image having excellent fastness (excellent light resistance, and thus, superior storability) with a high image quality can be obtained stably by using the ink jet ink composition according to the present embodiment as a black ink.

### EXAMPLES

Hereinbelow, the present disclosure will be described in more detail with reference to Examples, but the present disclosure is not limited to the Examples below.

<Preparation of Color Material>

(Synthesis of Exemplary Compounds 1 to 4)

Exemplary Compounds 1 to 4 were synthesized in accordance with the method described in Japanese Unexamined Patent Application Publication No. 2005-139427 above. Hereinbelow, the method for synthesizing the Exemplary Compound 1 will be described as a specific example.

(1) Synthesis of Compound 1-1

17.0 g of 7-aminonaphthalene-1,5-disulfonedisodium (the following Compound A) was added to 140.0 ml of water, 19.0 ml of concentrated hydrochloric acid was added dropwise thereto, and then the mixture was cooled to 0° C. After cooling, a liquid formed by dissolving 3.4 g of sodium nitrite in 12.0 ml of water was added thereto, and the mixture was stirred at 0° C. for 1 hour to perform a reaction. Then, to a solution formed by suspending 10.0 g of 2-amino-4-naphthyl-thiazole (the following Compound B) in 500.0 ml of water was added the solution after reaction at room temperature, and the mixture was stirred for 30 minutes. After addition of sodium acetate to the solution after completion of the stirring until the pH became 4, the mixture was heated and stirred at 40° C. for 2 hours. Further, after confirmation of loss of thiazole by means of liquid chromatography, sodium acetate was additionally added thereto until the pH became 7. The obtained slurry was filtered, and the wet cake taken out was dissolved in 400.0 ml of water, subjected to salting-out with 29.0 g of lithium chloride, and then suction-filtered. The obtained wet cake was dried to obtain a Compound 1-1 as a diazo component.

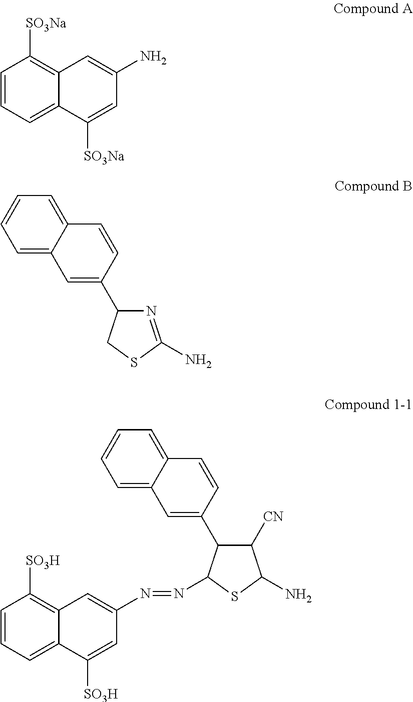

(2) Synthesis of Exemplary Compound 1

To 300.0 ml of phosphoric acid and 150.0 ml of acetic acid was added 6.3 g of 40% nitrosyl sulfuric acid, and the mixture was cooled to −2° C. To the mixture was added dropwise a solution formed by dissolving 10.0 g of the Compound 1-1 in 30.0 ml of water, and the mixture was stirred at an internal temperature of −2° C. to 0° C. for 1 hour. The solution was added dropwise to a solution formed by 9.0 g of the following Compound C in 450.0 ml of water at 5° C., and the mixture was stirred at an internal temperature of 5° C. for 1 hour. After stirring, the solution was heated to 40° C., 38.0 g of lithium chloride was added thereto, and the mixture was subjected to salting-out. The obtained slurry was filtered, the wet cake taken out was dissolved in 300 ml of water, and to the solution was added 100.0 ml of concentrated hydrochloric acid. The mixture was heated to 40° C., subjected to salting-out with 43.0 g of lithium chloride, and suction-filtered. The obtained wet cake was dissolved in 30.0 ml of water and 60.0 ml of methanol, neutralized to pH=7 with an aqueous lithium hydroxide solution, and then heated to 65° C. To the solution was added dropwise 250.0 ml of ethanol. Thereafter, the solution was cooled to room temperature and the precipitated crystal was collected by filtration. The obtained crystal was dissolved in 36.0 ml of water and the solution was charged in a cylindrical column packed with 50 ml of a sodium type of a strong acid cation exchange resin (a resin obtained by converting Amberlite IR-120B, trade name, manufactured by Organo Corporation, to a sodium type). The solution was passed through the packed column at 25° C. and a flow rate of about SV4. The pH of the passed aqueous solution was adjusted to 7 with a dilute aqueous lithium hydroxide solution, and the aqueous solution was filtered through a membrane filter having an average pore diameter of 0.22 μm. The filtrate was concentrated, dried, and solidified under reduced pressure, and then dried at 70° C. overnight to obtain an Exemplary Compound 1.

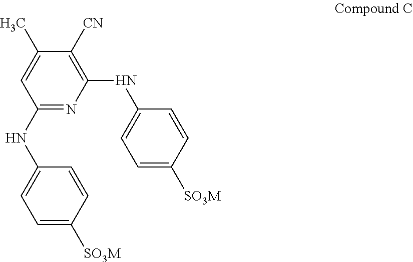

[Synthesis of Exemplary Compounds 5 to 7]

The Exemplary Compounds 5 to 7 were synthesized in accordance to the method described in Japanese Unexamined Patent Application Publication No. 2004-315741. Hereinbelow, the method for synthesizing Exemplary Compound 5 will be described as a specific example.

(1) Synthesis of Compound 5-1

20.1 g of 2-amino-5-naphthol-1,7-disulfonic acid and 12.6 g of p-toluene sulfonyl chloride were stirred at a pH of 8.0 to 8.5 and an internal temperature of 70° C. for 1 hour. After 30.0 ml of concentrated hydrochloric acid was added to the solution after stirring, the mixture was subjected to salting-out with lithium chloride and suction-filtered to obtain the following Compound 5-1.

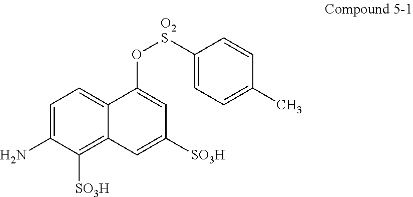

(2) Synthesis of Compound 5-2

28.4 g of the obtained Compound 5-1 was added to 300.0 ml of water, and dissolved in sodium carbonate while adjusting the pH to 6.0 to 8.0. To the solution was added 18.7 g of concentrated hydrochloric acid and the mixture was cooled to 0° C. Then, to the solution after cooling was added a solution formed by dissolving 4.3 g of sodium nitrite in 6.4 ml of water, and the mixture was stirred at 0° C. for 1 hour. After completion of stirring, to the reaction liquid was added a solution formed by suspending 19.1 g of 4-amino-5-hydroxy naphthalene-1,7-disulfonic acid in 200.0 ml of water, and the mixture was stirred at 10 to 20° C. for 12 hours while keeping the pH value to 2.4 to 2.8 with sodium carbonate. After completion of stirring, sodium carbonate was further added to the solution to adjust the pH value to 7.0 to 8.5, thereby obtaining a solution including a monoazo compound having a structure of the following Compound 5-2.

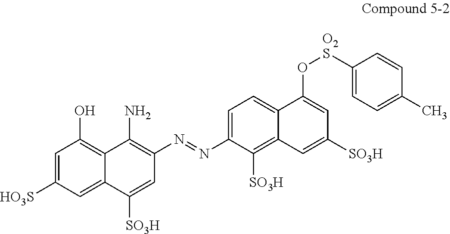

(3) Synthesis of Compound 5-3

14.4 g of 4-nitroaniline-2-sulfonic acid sodium was dissolved in 150.0 ml of water. To the solution was added dropwise 18.7 g of concentrated hydrochloric acid and then the mixture was cooled to 0° C. Then, to the solution after cooling was added a solution formed by dissolving 4.3 g of sodium nitrite in 6.4 ml of water. The solution was added dropwise to a solution including the monoazo compound of the Compound 5-2 obtained in the reaction above at 10 to 20° C. while keeping the pH value to 8.0 to 9.0 with sodium carbonate. After completion of dropwise addition, the reaction liquid was stirred at 15 to 30° C. for 2 hours, subjected to salting-out with lithium chloride, and suction-filtered. The obtained wet cake was dried to obtain a diazo compound having a structure of the following Compound 5-3.

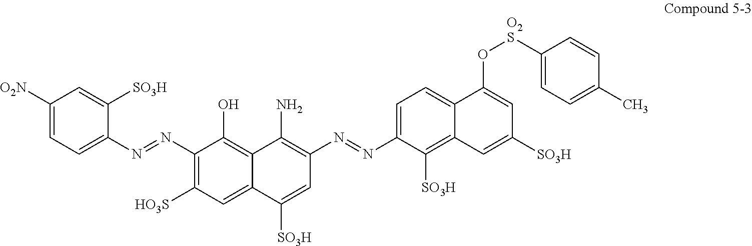

(4) Synthesis of Compound 5-4

As described above, the obtained Compound 5-3 was dissolved in 400 ml of water, heated to 70° C., and then stirred for 1 hour while keeping the pH value to 10.5 to 11.0 with sodium hydroxide. After completion of stirring, the solution was cooled to room temperature, and concentrated hydrochloric acid was added dropwise thereto until the pH became 7.0 to 8.0. The reaction liquid was subjected to salting-out with lithium chloride, and suction-filtered. The obtained wet cake was dried to obtain the following Compound 5-4.

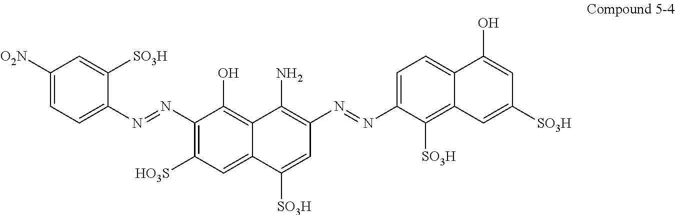

(5) Synthesis of Exemplary Compound 5

12.2 g of monosodium 2-aminobenzene-1,4-disulfonate was added to and dissolved in 70.0 ml of water with the pH value adjusted to 5.0 to 7.0 with sodium hydroxide. 18.7 g of hydrochloric acid was added thereto, and then the mixture was cooled to 0° C. Then, to the solution after cooling was added a solution formed by dissolving 3.2 g of sodium nitrite in 4.8 ml of water. The reaction liquid was added dropwise to a solution formed by dissolving the Compound 5-4 in 300 ml of water at 10 to 20° C. while adjusting the pH value to 8.0 to 9.0 with sodium carbonate. After completion of dropwise addition, the reaction liquid was stirred at 15 to 30° C. for 3 hours, subjected to salting-out with lithium chloride, and suction-filtered. The obtained wet cake was dissolved in 200.0 ml of water, crystallized by the addition of 150 ml of methanol and 350.0 ml of 2-propanol, and then filtered. The obtained crystals were dissolved in 50.0 ml of water and the solution was passed through a packed column of the cylindrical column packed with 50 ml of a sodium type of a strong acid cation exchange resin (a resin obtained by converting Amberlite IR-120B, trade name, manufactured by Organo Corporation, to a sodium type) at 25° C. and a flow rate of about SV4. The pH of the passed aqueous solution was adjusted to 7 with a dilute aqueous lithium hydroxide solution, and then the aqueous solution was filtered through a membrane filter having an average pore diameter of 0.22 μm. The filtrate was concentrated, dried and solidified under reduced pressure, and then dried at 70° C. overnight to obtain an Exemplary Compound 5.

[Synthesis of Exemplary Compounds 8 and 9]

Exemplary Compounds 8 and 9 were synthesized in accordance with the method described in Japanese Unexamined Patent Application Publication No. 2008-24909 above. Hereinbelow, the method for synthesizing the Exemplary Compound 8 will be described as a specific example.

(1) Synthesis of Compound 8-1

100.0 g of a bisazo compound (the following Compound D) was dissolved in 200 ml of water. The solution was added dropwise to a solution formed by suspending 15.4 g of cyanuric chloride (the following Compound E) in 90.0 ml of water at an internal temperature of 0 to 5° C. Further, to the solution was added dropwise an aqueous solution formed by dissolving 9.5 g of sodium carbonate in 50.0 ml of water while keeping the temperature at 0 to 5° C., and then the mixture was stirred for 30 minutes. After stirring, the reaction temperature of the reaction liquid was raised to 35° C., and the reaction liquid was stirred for an additional 3 hours. To the reaction liquid was added dropwise 540.0 ml of isopropanol, and the precipitated product was suction-filtered. The obtained wet cake was washed with isopropanol and then dried to obtain the following Compound 8-1.

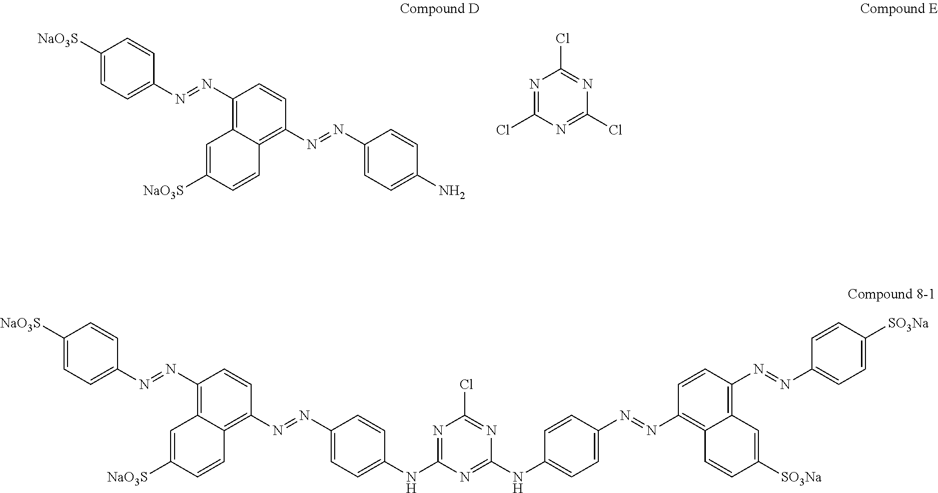

(2) Synthesis of Exemplary Compound 8

As described above, to a solution formed by dissolving 50.0 g of the obtained Compound 8-1 in a mixed solvent of 250.0 ml of water and 250.0 ml of dimethylacetamide were added 5.3 g of di-n-butylamine and 10.3 g of sodium hydrogen carbonate, and the mixture was stirred at an internal temperature of 70° C. for 5 hours. To the reaction liquid was added dropwise 500.0 ml of isopropanol, and the precipitated product was suction-filtered. The obtained wet cake was washed with isopropanol, then dried, dissolved in water again, crystallized with isopropanol and then suction-filtered. The obtained crystals were dissolved in 50.0 ml of water and the solution was passed through a packed column of the cylindrical column packed with 50 ml of a sodium type of a, strong acid cation exchange resin (a resin obtained by converting Amberlite IR-120B, trade name, manufactured by Organo Corporation, to a sodium type) at 25° C. and a flow rate of about SV4. The pH of the passed aqueous solution was adjusted to 7 with a dilute aqueous lithium hydroxide solution, and then the aqueous solution was filtered through a membrane filter having an average pore diameter of 0.22 μm. The filtrate was concentrated, dried, and solidified under reduced pressure, and then dried at 70° C. overnight to obtain an Exemplary Compound 8.

<Preparation of Ink Composition>

For all the ink compositions, a colorant selected from the Exemplary Compounds 1 to 9 obtained above, the following Comparative Compounds 1 and 2, which are trisazo compounds having different structures from the general formula (II) of the present disclosure, the following Comparative Compound 3, which is a tetraazo compound having a different structure from the general formula (III) of the present disclosure, and C. I. Direct Black 154, was used as a color material.

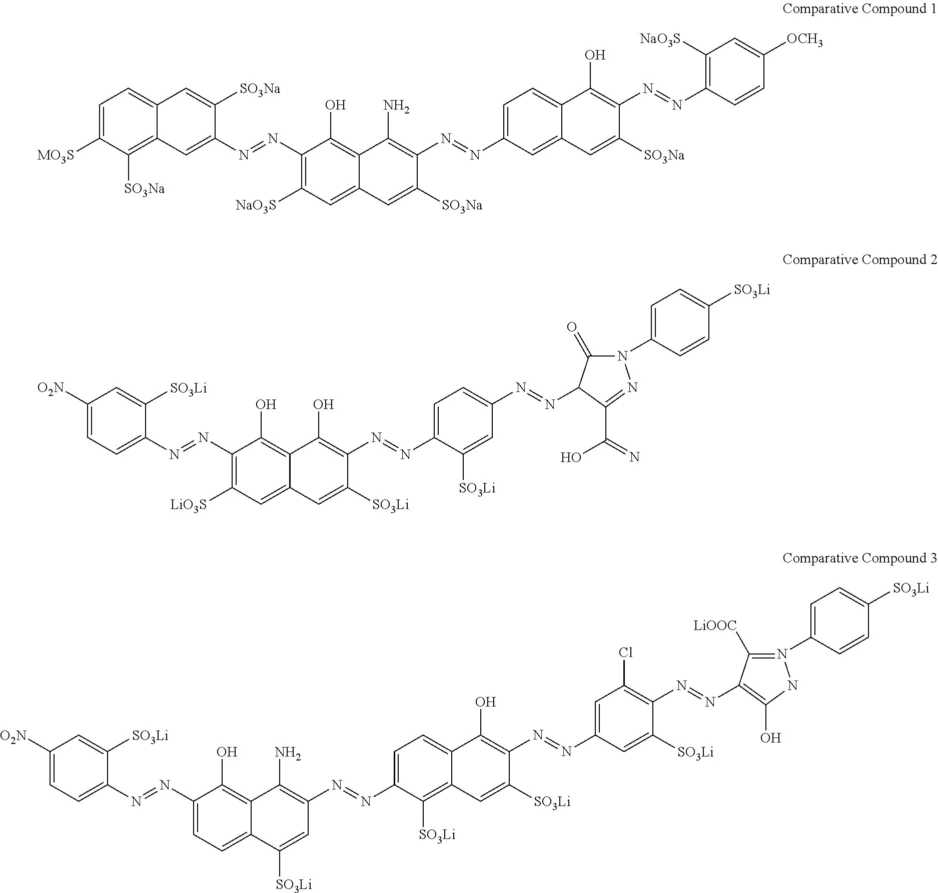

The ink compositions in Examples were prepared in accordance with the preparation method of Example 1 shown below such that the respective components were at the content ratios (% by mass) described at the upper parts of Tables 1-1 to 1-4, and the ink compositions in Comparative Examples were prepared in accordance with the preparation method of Example 1 shown below such that the respective components were at the content ratios (% by mass) described at the upper parts of Tables 2-1 and 2-2.

Furthermore, in the lower parts of Tables 1-1 to 1-4 and Tables 2-1 to 2-2, the total content of the dyes in the ink composition (dye concentration), the ratio of the diazo compound/the trisazo compound in the ink composition, and the ratio of (the diazo compound+the trisazo compound in ink)/the tetraazo compound were described as the characteristics of each ink.

[Preparation of Ink Composition of Example 1]

Based on the total amount of the ink composition, the Exemplary Compound 1 as a first color material represented by the general formula (I) was weighed to a concentration of 2.9% by mass, the Exemplary Compound 5 as a second color material represented by the general formula (II) was weighed to a concentration of 0.7% by mass, the Exemplary Compound 8 as a third color material represented by the general formula (III) was weighed to a concentration of 0.7% by mass, Surfynol E1010 (manufactured by Nissin Chemical Industry Co., Ltd.) as an acetylene glycol-based surfactant of the general formula (IV) was weighed to concentration of 0.1% by mass, glycerin was weighed to concentration of 10.0% by mass, 1,2-pentanediol was weighed to concentration of 3.0% by mass, 2-pyrrolidone was weighed to concentration of 2.0% by mass, xylitol was weighed to concentration of 1.0% by mass, and these were added to ion exchange water, followed by mixing.

The solution was sufficiently stirred and then filtered through a filter having a pore diameter of 0.5 μm to obtain an ink composition of Example 1.

TABLE 1
Table 1-1 (units of the components shown in Table: % by mass)

| | | Example | | | | | |
|---|---|---|---|---|---|---|---|
| Name of components | | 1 | 2 | 3 | 4 | 5 | 6 |
| Bisazo | Exemplary | 2.7 | 2.7 | 2.7 | 2.7 | 2.7 | 2.7 |
| compound | Compound 1 | | | | | | |
| of the | Exemplary | | | | | | |
| general | Compound 2 | | | | | | |
| formula (I) | Exemplary | | | | | | |
| | Compound 3 | | | | | | |
| | Exemplary | | | | | | |
| | Compound 4 | | | | | | |
| Trisazo | Exemplary | 0.7 | 0.7 | 0.7 | 0.7 | 0.7 | 0.7 |
| dye of the | Compound 5 | | | | | | |
| general | Exemplary | | | | | | |
| formula (II) | Compound 6 | | | | | | |
| | Exemplary | | | | | | |
| | Compound 7 | | | | | | |
| | Comparative | | | | | | |
| | Compound 1 | | | | | | |
| | Comparative | | | | | | |
| | Compound 2 | | | | | | |
| Tetraazo | Exemplary | 0.7 | 0.7 | 0.7 | 0.7 | 0.7 | 0.7 |
| dye of the | Compound 8 | | | | | | |
| general | Exemplary | | | | | | |
| formula (III) | Compound 9 | | | | | | |
| | Comparative | | | | | | |
| | Compound 3 | | | | | | |

| | | | | | | |
|---|---|---|---|---|---|---|
| C.I. Direct Black 154 | | | | | | |
| Glycerin | 10.0 | 10.0 | 10.0 | 10.0 | 10.0 | 10.0 |
| 1,5-Pentanediol | | | | | | |
| 1,2-Pentanediol | 3.0 | 3.0 | 3.0 | 3.0 | 3.0 | |
| Diethylene glycol | | | | | | |
| Triethylene glycol | | | | | | 2.0 |
| 2-Pyrrolidone | 2.0 | 2.0 | 2.0 | 2.0 | | 3.0 |
| Trimethylolpropane | | | | | 3.0 | |
| Xylitol | 1.0 | 1.0 | 1.0 | 1.0 | | |
| Surfynol E1010 *1 | 0.1 | 0.3 | 0.5 | 0.7 | 0.5 | |
| Acetylenol E100 *2 | | | | | | 0.5 |
| MOPS | | | | | | |
| Water | 79.8 | 79.6 | 79.4 | 79.2 | 79.4 | 80.4 |
| Dye concentration | 4.1 | 4.1 | 4.1 | 4.1 | 4.1 | 4.1 |
| (% by mass) | | | | | | |
| Ratio of bisazo | 3.9 | 3.9 | 3.9 | 3.9 | 3.9 | 3.9 |
| dye/trisazo dye | | | | | | |
| Ratio of | 4.9 | 4.9 | 4.9 | 4.9 | 4.9 | 4.9 |
| (bisazo dye + | | | | | | |
| trisazo dye)/tetraazo | | | | | | |
| dye | | | | | | |

*1 Acetylene glycol-based surfactant manufactured by Nissin Chemical Industry Co., Ltd.
*2 Acetylene glycol-based surfactant manufactured by Kawaken Fine Chemicals Co., Ltd.

TABLE 2
Table 1-2 (units of the components shown in Table: % by mass)

| | | Example | | | | | |
|---|---|---|---|---|---|---|---|
| Name of components | | 7 | 8 | 9 | 10 | 11 | 12 |
| Bisazo | Exemplary | 2.7 | 2.0 | 2.7 | 3.4 | 4.1 | 2.0 |
| compound | Compound 1 | | | | | | |
| of the | Exemplary | | | | | | |
| general | Compound 2 | | | | | | |
| formula (I) | Exemplary | | | | | | |
| | Compound 3 | | | | | | |
| | Exemplary | | | | | | |
| | Compound 4 | | | | | | |
| Trisazo | Exemplary | 0.7 | 0.5 | 0.7 | 0.8 | 0.7 | 2.0 |
| dye of the | Compound 5 | | | | | | |
| general | Exemplary | | | | | | |
| formula (II) | Compound 6 | | | | | | |
| | Exemplary | | | | | | |
| | Compound 7 | | | | | | |
| | Comparative | | | | | | |
| | Compound 1 | | | | | | |
| | Comparative | | | | | | |
| | Compound 2 | | | | | | |
| Tetraazo | Exemplary | 0.7 | 0.5 | 0.7 | 0.7 | 1.2 | 1.0 |
| dye of the | Compound 8 | | | | | | |
| general | Exemplary | | | | | | |
| formula (III) | Compound 9 | | | | | | |
| | Comparative | | | | | | |
| | Compound 3 | | | | | | |

| | | | | | | |
|---|---|---|---|---|---|---|
| C.I. Direct Black 154 | | | | | | |
| Glycerin | | 10.0 | 10.0 | 10.0 | 10.0 | 10.0 |
| 1,5-Pentanediol | 5.0 | | | | | |
| 1,2-Pentanediol | | 3.0 | 3.0 | 3.0 | 3.0 | 3.0 |
| Diethylene glycol | 5.0 | | | | | |
| Triethylene glycol | | | | | | |
| 2-Pyrrolidone | 2.0 | 2.0 | 2.0 | 2.0 | 2.0 | 2.0 |
| Trimethylolpropane | | 3.0 | 3.0 | 3.0 | 3.0 | 3.0 |
| Xylitol | | | | | | |
| Surfynol E1010 *1 | | 0.5 | 0.5 | 0.5 | 0.5 | 0.5 |
| Acetylenol E100 *2 | 0.5 | | | | | |
| MOPS | | | | | | |
| Water | 80.1 | 78.5 | 77.4 | 76.6 | 75.5 | 76.5 |
| Dye concentration | 4.1 | 3.0 | 4.1 | 4.9 | 6.0 | 5.0 |
| (% by mass) | | | | | | |
| Ratio of bisazo | 3.9 | 4.0 | 3.9 | 4.3 | 5.9 | 1.0 |
| dye/trisazo dye | | | | | | |
| Ratio of | 4.9 | 5.0 | 4.9 | 6.0 | 4.0 | 4.0 |
| (bisazo dye + | | | | | | |
| trisazo dye)/ | | | | | | |
| tetraazo dye | | | | | | |

*1 Acetylene glycol-based surfactant manufactured by Nissin Chemical Industry Co., Ltd.
*2 Acetylene glycol-based surfactant manufactured by Kawaken Fine Chemicals Co., Ltd.

TABLE 3
Table 1-3 (units of the components shown in Table: % by mass)

| | | Example | | | | | |
|---|---|---|---|---|---|---|---|
| Name of components | | 13 | 14 | 15 | 16 | 17 | 18 |
| Bisazo | Exemplary | | | | 2.7 | 2.7 | 2.0 |
| compound | Compound 1 | | | | | | |
| of the | Exemplary | 2.7 | | | | | |
| general | Compound 2 | | | | | | |
| formula (I) | Exemplary | | 2.7 | | | | |
| | Compound 3 | | | | | | |
| | Exemplary | | | 2.7 | | | |
| | Compound 4 | | | | | | |
| Trisazo | Exemplary | 0.7 | 0.7 | 0.7 | | | 0.4 |
| dye of the | Compound 5 | | | | | | |
| general | Exemplary | | | | 0.7 | | |
| formula (II) | Compound 6 | | | | | | |
| | Exemplary | | | | | 0.7 | |
| | Compound 7 | | | | | | |
| | Comparative | | | | | | |
| | Compound 1 | | | | | | |
| | Comparative | | | | | | |
| | Compound 2 | | | | | | |
| Tetraazo | Exemplary | 0.7 | | 0.7 | | 0.7 | 0.4 |
| dye of the | Compound 8 | | | | | | |
| general | Comparative | | 0.7 | | 0.7 | | |
| formula (III) | Compound 9 | | | | | | |
| | Comparative | | | | | | |
| | Compound 3 | | | | | | |

| | | | | | | |
|---|---|---|---|---|---|---|
| C.I. Direct Black 154 | | | | | | |
| Glycerin | 10.0 | 10.0 | 10.0 | 10.0 | 10.0 | 10.0 |
| 1,5-Pentanediol | | | | | | |
| 1,2-Pentanediol | 3.0 | 3.0 | 3.0 | 3.0 | 3.0 | |
| Diethylene glycol | | | | | | |
| Triethylene glycol | | | | | | |
| 2-Pyrrolidone | 2.0 | 2.0 | 2.0 | 2.0 | 2.0 | 2.0 |
| Trimethylolpropane | 3.0 | 3.0 | 3.0 | 3.0 | 3.0 | 3.0 |
| Xylitol | | | | | | |
| Surfynol E1010 *1 | 0.5 | 0.5 | 0.5 | 0.5 | 0.5 | 0.5 |
| Acetylenol E100 *2 | | | | | | |
| MOPS | | | | | | |
| Water | 77.4 | 77.4 | 77.4 | 77.4 | 77.4 | 78.7 |
| Dye concentration | 4.1 | 4.1 | 4.1 | 4.1 | 4.1 | 2.8 |
| (% by mass) | | | | | | |
| Ratio of bisazo | 3.9 | 3.9 | 3.9 | 3.9 | 3.9 | 5.0 |
| dye/trisazo dye | | | | | | |
| Ratio of | 4.9 | 4.9 | 4.9 | 4.9 | 4.9 | 6.0 |
| (bisazo dye + | | | | | | |
| trisazo dye)/tetraazo | | | | | | |
| dye | | | | | | |

*1 Acetylene glycol-based surfactant manufactured by Nissin Chemical Industry Co., Ltd.
*2 Acetylene glycol-based surfactant manufactured by Kawaken Fine Chemicals Co., Ltd.

TABLE 4
Table 1-4 (units of the components shown in Table: % by mass)

| | | Example | | | | | |
|---|---|---|---|---|---|---|---|
| Name of components | | 19 | 20 | 21 | 22 | 23 | 24 |
| Bisazo | Exemplary | 4.6 | 1.0 | 1.0 | 3.6 | 3.7 | 2.7 |
| compound | Compound 1 | | | | | | |
| of the | Exemplary | | | | | | |
| general | Compound 2 | | | | | | |
| formula (I) | Exemplary | | | | | | |
| | Compound 3 | | | | | | |
| | Exemplary | | | | | | |
| | Compound 4 | | | | | | |
| Trisazo | Exemplary | 1.2 | 2.0 | 3.0 | 0.8 | 0.5 | 0.7 |
| dye of | Compound 5 | | | | | | |
| the general | Exemplary | | | | | | |
| formula (II) | Compound 6 | | | | | | |
| | Exemplary | | | | | | |
| | Compound 7 | | | | | | |
| | Comparative | | | | | | |
| | Compound 1 | | | | | | |
| | Comparative | | | | | | |
| | Compound 2 | | | | | | |
| Tetraazo | Exemplary | 1.2 | 1.0 | 1.0 | 0.6 | 0.8 | 0.7 |
| dye of | Compound 8 | | | | | | |
| the general | Comparative | | | | | | |
| formula (III) | Compound 9 | | | | | | |
| | Comparative | | | | | | |
| | Compound 3 | | | | | | |

| | | | | | | |
|---|---|---|---|---|---|---|
| C.I. Direct Black 154 | | | | | | |
| Glycerin | 10.0 | 10.0 | 10.0 | 10.0 | 10.0 | 10.0 |
| 1,5-Pentanediol | | | | | | |
| 1,2-Pentanediol | 3.0 | 3.0 | 3.0 | 3.0 | 3.0 | 3.0 |
| Diethylene glycol | | | | | | |
| Triethylene glycol | | | | | | |
| 2-Pyrrolidone | 2.0 | 2.0 | 2.0 | 2.0 | 2.0 | 2.0 |
| Trimethylolpropane | 3.0 | 3.0 | 3.0 | 3.0 | 3.0 | |
| Xylitol | | | | | | 1.0 |
| Surfynol E1010 *1 | 0.5 | 0.5 | 0.5 | 0.5 | 0.5 | 0.5 |
| Acetylenol E100 *2 | | | | | | |
| MOPS | | | | | | |
| Water | 74.5 | 77.5 | 76.5 | 76.5 | 76.5 | 78.9 |
| Dye concentration | 7.0 | 4.0 | 5.0 | 5.0 | 5.0 | 4.1 |
| (% by mass) | | | | | | |
| Ratio of bisazo | 3.8 | 0.5 | 0.3 | 4.5 | 7.4 | 3.9 |
| dye/trisazo dye | | | | | | |
| Ratio of | 4.8 | 3.0 | 4.0 | 7.3 | 5.3 | 4.9 |
| (bisazo dye + | | | | | | |
| trisazo dye)/tetraazo | | | | | | |
| dye | | | | | | |

*1 Acetylene glycol-based surfactant manufactured by Nissin Chemical Industry Co., Ltd.
*2 Acetylene glycol-based surfactant manufactured by Kawaken Fine Chemicals Co., Ltd.

TABLE 5
Table 2-1 (units of the components shown in Table: % by mass)

| | | Comparative Example | | | | | |
|---|---|---|---|---|---|---|---|
| Name of components | | 1 | 2 | 3 | 4 | 5 | 6 |
| Bisazo | Exemplary | 2.7 | 2.7 | 2.7 | 2.7 | | |
| compound | Compound 1 | | | | | | |
| of the | Exemplary | | | | | 3.0 | 3.0 |
| general | Compound 2 | | | | | | |
| formula (I) | Exemplary | | | | | | |
| | Compound 3 | | | | | | |
| | Exemplary | | | | | | |
| | Compound 4 | | | | | | |
| Trisazo | Exemplary | 0.7 | 0.7 | 0.7 | 0.7 | | |
| dye of | Compound 5 | | | | | | |
| the general | Exemplary | | | | | | |
| formula (II) | Compound 6 | | | | | | |
| | Exemplary | | | | | | |
| | Compound 7 | | | | | | |
| | Comparative | | | | | | |
| | Compound 1 | | | | | | |
| | Comparative | | | | | 3.0 | |
| | Compound 2 | | | | | | |
| Tetraazo | Exemplary | 0.7 | 0.7 | 0.7 | 0.7 | | |
| dye of | Compound 8 | | | | | | |
| the general | Comparative | | | | | | |
| formula (III) | Compound 9 | | | | | | |
| | Comparative | | | | | | 3.0 |
| | Compound 3 | | | | | | |

| | | | | | | |
|---|---|---|---|---|---|---|
| C.I. Direct Black 154 | | | | | | |
| Glycerin | 10.0 | 10.0 | 10.0 | 10.0 | 10.0 | 10.0 |
| 1,5-Pentanediol | | | | | | |
| 1,2-Pentanediol | 3.0 | 3.0 | 3.0 | | | |
| Diethylene glycol | | | | | | |
| Triethylene glycol | | | | 2.0 | 2.0 | 2.0 |
| 2-Pyrrolidone | 2.0 | 2.0 | 2.0 | 3.0 | 3.0 | 3.0 |
| Trimethylolpropane | | | 3.0 | | | |
| Xylitol | 1.0 | 1.0 | | | | |
| Surfynol E1010 *1 | 0.0 | 1.0 | 1.0 | | | |
| Acetylenol E100 *2 | | | | 1.0 | 1.0 | 1.0 |
| MOPS | | | | | | |
| Water | 79.9 | 78.9 | 76.9 | 79.9 | 78.0 | 78.0 |
| Dye concentration | 4.1 | 4.1 | 4.1 | 4.1 | 6.0 | 6.0 |
| (% by mass) | | | | | | |
| Ratio of bisazo | 3.9 | 3.9 | 3.9 | 3.9 | 1.0 | |
| dye/trisazo dye | | | | | | |
| Ratio of | 4.9 | 4.9 | 4.9 | 4.9 | — | 1.0 |
| (bisazo dye + | | | | | | |
| trisazo dye)/tetraazo | | | | | | |
| dye | | | | | | |

*1 Acetylene glycol-based surfactant manufactured by Nissin Chemical Industry Co., Ltd.
*2 Acetylene glycol-based surfactant manufactured by Kawaken Fine Chemicals Co., Ltd.

TABLE 6
Table 2-2 (units of the components shown in Table: % by mass)

| | | Comparative Example | | | | | |
|---|---|---|---|---|---|---|---|
| Name of components | | 7 | 8 | 9 | 10 | 11 | 12 |
| Bisazo | Exemplary | | | 4.0 | 2.7 | 2.0 | |
| compound | Compound 1 | | | | | | |
| of the | Exemplary | | 2.7 | | | | |
| general | Compound 2 | | | | | | |
| formula (I) | Exemplary | | | | | | |
| | Compound 3 | | | | | | |
| | Exemplary | 3.4 | | | | | |
| | Compound 4 | | | | | | |
| Trisazo | Exemplary | | | | | | |
| dye of | Compound 5 | | | | | | |
| the general | Exemplary | | | | | | |
| formula (II) | Compound 6 | | | | | | |
| | Exemplary | | | | | | |
| | Compound 7 | | | | | | |
| | Comparative | | | | 0.7 | | |
| | Compound 1 | | | | | | |
| | Comparative | | | | | | |
| | Compound 2 | | | | | | |
| Tetraazo | Exemplary | 0.7 | | | 0.7 | | |
| dye of | Compound 8 | | | | | | |
| the general | Comparative | | 0.7 | | | | |
| formula (III) | Compound 9 | | | | | | |
| | Comparative | | | | | | |
| | Compound 3 | | | | | | |

| | | | | | | |
|---|---|---|---|---|---|---|
| C.I. Direct Black 154 | | | | | 2.0 | 4.0 |
| Glycerin | | 10.0 | 10.0 | 10.0 | 10.0 | 10.0 |
| 1,5-Pentanediol | 5.0 | | | | | |
| 1,2-Pentanediol | | 4.0 | 3.0 | 3.0 | 3.0 | 3.0 |
| Diethylene glycol | 5.0 | | | | | |
| Triethylene glycol | | 3.0 | | | | |
| 2-Pyrrolidone | 2.0 | 4.0 | 2.0 | 2.0 | 2.0 | 2.0 |
| Trimethylolpropane | | | | | | |
| Xylitol | | | 1.0 | 1.0 | 1.0 | 1.0 |
| Surfynol E1010 *1 | | 1.0 | 0.5 | 0.5 | 0.5 | 0.5 |
| Acetylenol E100 *2 | 0.8 | | | | | |
| MOPS | | | | | | |
| Water | 80.1 | 74.6 | 79.5 | 79.4 | 79.5 | 79.5 |
| Dye concentration | 4.1 | 3.4 | 4.0 | 4.1 | 4.0 | 4.0 |
| (% by mass) | | | | | | |
| Ratio of bisazo | — | — | — | 3.9 | — | — |
| dye/trisazo dye | | | | | | |
| Ratio of | 4.9 | 3.9 | — | 4.9 | — | — |
| (bisazo dye + | | | | | | |
| trisazo dye)/tetraazo | | | | | | |
| dye | | | | | | |

*1 Acetylene glycol-based surfactant manufactured by Nissin Chemical Industry Co., Ltd.
*2 Acetylene glycol-based surfactant manufactured by Kawaken Fine Chemicals Co., Ltd.

<Method for Evaluation of Ink Composition>

All the evaluations of the ink composition were carried out by mounting each of the ink compositions described in Tables 1-1 to 1-4 and Tables 2-1 to 2-2 as a black ink on an ink jet recording apparatus, respectively. Further, for all the evaluations below, a thermal ink jet printer (LPR-E5000) manufactured by Sony Corporation, having a line head, was used.

[Color Bleeding Property]

With a recording density of 600 dpi×600 dpi and a discharge amount of 3.5 μL, yellow, magenta, and cyan monochromic patterns close to black were printed on ink jet glossy paper (IJ-RC-UF170) manufactured by Mitsubishi Paper Mills Limited as a recording medium with a recording duty varying from 0% to 100% at an interval of 10%. Then, the image was dried naturally at a temperature of 24° C. and a relative humidity of 60% for 24 hours, and evaluated for the color bleeding property. The evaluation criteria for the color bleeding property were as follows. Further, the evaluation results are shown in Table 3. Further, in the present Example, according to the following evaluation criteria, A indicates an ink composition having a particularly preferable color bleeding property, B indicates an ink composition having a preferable color bleeding property, and C indicates an ink composition having an unacceptable color bleeding property.

A: Even with a recording duty of 80% or more, there is no color mixing and the boundary is clear.

B: Even with a recording duty of 60% or more, there is no color mixing and the boundary is clear.

C: Even with a recording duty of less than 60%, color mixing occurs.

[Intermittent Discharging Stability]

Using an ink jet recording apparatus, the recording density was set to 600 dpi×600 dpi, and the ink was discharged from a predetermined nozzle under an environment of a temperature of 10° C. and a humidity of 15% RH. Then, the above-described predetermined nozzle was not used for a certain period of time, the ink was discharged from the above-described predetermined nozzle again, and recording was performed on ink jet glossy paper (IJ-RC-UF170) manufactured by Mitsubishi Paper Mills Limited as a recording medium. The image thus obtained was observed with the naked eye and evaluated for the intermittent discharging stability. The evaluation criteria for the intermittent discharging stability were as follows. Further, the evaluation results are shown in Table 3. Further, in the present Example, according to the following evaluation criteria, A indicates an ink composition having particularly preferable intermittent discharging stability, B indicates an ink composition having preferable intermittent discharging stability, and C indicates an ink composition having unacceptable intermittent discharging stability.

A: Recording was normally performed even after the nozzle was not used for 10 seconds.

B: Recording was normally performed even after the nozzle was not used for 5 seconds.

C: Non-discharging or blurring of recording was observed after the nozzle was not used for 5 seconds.

[Fastness of Image]

Ink jet glossy paper (IJ-RC-UF170) manufactured by Mitsubishi Paper Mills Limited as a recording medium with a recording duty varying from 0% to 100% at an interval of 10% was used as a recording medium, and an image was recorded thereon and dried naturally at a temperature of 24° C. and a relative humidity of 60% for 24 hours.

The recorded matter thus obtained was used and measured for a* and b* in the L*a*b* color system defined by the CIE (International Commission on Illumination) and an optical density, using a spectrophotometer (Spectorolino; manufactured by Gretag Macbeth) under the conditions of a light source of D50 and a field of view of 2°. Thereafter, the light resistance test and the ozone resistance test shown below were carried out, and the fastness of an image was evaluated according to the following examination criteria. The evaluation criteria for the fastness of an image were as follows. Further, the evaluation results are shown in Table 3. Further, in the Example, according to the following evaluation criteria, A indicates an ink composition having particularly preferable fastness, B indicates an ink composition having preferable fastness, and C indicates an ink composition having unacceptable fastness.

A: The results of the light resistance test and the ozone resistance test were both O.

B: The results of the light resistance test and the ozone resistance test were both Δ or any one of the results is Δ.

C: The results of the light resistance test and the ozone resistance test were both x or any one of the results is x.

(Light Resistance Test)

Under the above-described conditions, an initial optical density (OD) was measured, and then the recorded matter was exposed for 180 hours using a Super Xenon Weather Meter XL-75 (manufactured by Suga Test Instruments Co., Ltd.) under the conditions of an irradiation intensity of 60 kilolux, an in-bath temperature of 22° C., and a relative humidity of 60%. Then, the optical density (OD) after the exposure test was measured using a spectrophotometer (Spectrolino; manufactured by Gretag Macbeth) under the conditions of a light source of D50 and a field of view of 2°. From these measurement results, the remaining optical density (ROD [%]) was measured by the following equation and the light resistance was evaluated in accordance with the following scoring criteria. Further, in the present Example, according to the following evaluation criteria, O indicates an ink composition having particularly preferable light resistance, Δ indicates an ink composition having preferable light resistance, and x indicates an ink composition having unacceptable light resistance.

ROD(%)=(OD after exposure test/initial OD)×100

O: ROD of 80% or more

Δ: ROD of 70% or more and less than 80%

x: ROD of less than 70%

[Test of Ozone Resistance]

The initial optical densities (OD) were measured under the above-described conditions, and the recorded matter was exposed for 48 hours under the conditions of 24° C., a relative humidity of 60% RH, and an ozone concentration of 5 ppm, using an Ozone Weather Meter OMS-H manufactured by Suga Test Instruments Co., Ltd. Then, the optical density (OD) after the exposure test was measured using a spectrophotometer (Spectrolino; manufactured by Gretag Macbeth) under the conditions of a light source of D50 and a field of view of 2°. From these measurement results, the remaining optical density (ROD [%]) was measured the following equation and the ozone resistance was evaluated in accordance with the following scoring criteria. Further, in the present Example, according to the following evaluation criteria, O indicates an ink composition having particularly preferable ozone resistance, Δ indicates an ink composition having preferable ozone resistance, and x indicates an ink composition having unacceptable ozone resistance.

ROD(%)=(OD after exposure test/initial OD)×100

O: ROD of 80% or more

Δ: ROD of 70% or more and less than 80%

x: ROD of less than 70%

[Recording Durability]

After applying a predetermined number of electrical pulse to a heater (heating element) of a recording head, ink jet glossy paper (IJ-RC-UF170) manufactured by Mitsubishi Paper Mills Limited used as a recording medium, and recording was performed thereon. The image thus obtained was observed with the naked eye, and found to have no occurrence of deterioration of the heater due to cognation or disconnection. The evaluation criteria for the recording durability were as follows. Further, the evaluation results are shown in Table 3. Further, in the present Example, according to the following evaluation criteria, A indicates an ink composition having particularly preferable recording durability, B indicates an ink composition having preferable recording durability, and C indicates an ink composition having unacceptable recording durability.

A: Even when 4.0×10⁸ pulse was applied, recording was normally performed.

B: Even when 2.0×10′ pulse or more and 4.0×10⁸ pulse or less was applied, abnormal recording due to deterioration of the heater was found.

C: When less than 2.0×10⁸ pulse was applied, abnormal recording due to deterioration of the heater was found.

[Color Tone and Recording Medium Selectivity]

In the present evaluation, two kinds of paper, glossy paper and plain paper, were used as a recording medium. Specifically, using ink jet glossy paper (IJ-RC-UF170) manufactured by Mitsubishi Paper Mills Limited as the glossy paper and plain paper (My Paper) manufactured by Ricoh Company, Ltd.) as the plain paper, the color tone and the recording medium selectivity were evaluated. An image with a recording duty varying from 0% to 100% at an interval of 10% was recorded on the two kinds of paper and the image was dried naturally at a temperature of 24° C. and a relative humidity of 60% for 24 hours.

The recorded matter thus obtained was used and measured for L*, a*, and b* in the L*a*b* color system defined by the CIE (International Commission on Illumination) and an optical density, using a spectrophotometer (Spectorolino; manufactured by Gretag Macbeth) under the conditions of a light source of D50 and a field of view of 2°. Thereafter, the color tone and the recording medium selectivity were evaluated according to the following examination criteria. The evaluation criteria for the color tone and the recording medium selectivity were as follows. Further, the evaluation results are shown in Table 3. Further, in the present Example, according to the following evaluation criteria, A indicates an ink composition having a particularly preferable color tone and recording medium selectivity, B indicates an ink composition having a preferable color tone and recording medium selectivity, and C indicates an ink composition having an unacceptable color tone and recording medium selectivity.

A: The results of the color tone and the recording medium selectivity were both O.

B: The results of the color tone and the recording medium selectivity were both Δ or any one of the results was Δ.

C: The results of the color tone and the recording medium selectivity were both x or any one of the results was x.

(Color Tone)

Among the recorded matters above, the image recorded on ink jet glossy paper (IJ-RC-UF170) manufactured by Mitsubishi Paper Mills Limited was evaluated on the color tone. Further, in the present Example, according to the following evaluation criteria, O indicates an ink composition having particularly preferable black color tone, Δ indicates an ink composition having preferable black color tone, and x indicates an ink composition having unacceptable black color tone.

O: An image having a recording duty of 100% satisfies a condition of 0≦L*≦30, or all the images having a recording duty of 10% to 100% satisfy a condition of −15≦a*≦15 and −15≦b*≦15.

Δ: An image having a recording duty of 100% satisfies a condition of 30≦L*≦50, all the images having a recording duty of 10% to 100% satisfy a condition of −20≦a*≦20 or −20≦b*≦20, or at least one of the images having a recording duty of 10% to 100% do not satisfy a condition of −15≦a*≦15 or −15≦b*≦15.

x: An image having a recording duty of 100% satisfies a condition of 50≦L*, or at least one of the images having a recording duty of 10% to 100% do not satisfy a condition of −20≦a*≦20 or −20≦b*≦20.

(Recording Medium Selectivity)

The two kinds of recorded matters above were evaluated on the color tone according to the examination criteria as described below. Further, in the present Example, according to the following evaluation criteria, O indicates an ink composition having particularly preferable recording medium selectivity, Δ indicates an ink composition having preferable recording medium selectivity, and x indicates an ink composition having unacceptable recording medium selectivity.

O: Both of the plain paper and the glossy paper satisfy a condition of −15≦a*≦15 or −15≦b*≦15 for all the images having a recording duty of 10% to 100%.

Δ: Both of the plain paper and the glossy paper satisfy a condition of −20≦a*≦20 or −20≦b*≦20 for all the images having a recording duty of 10% to 100% and do not satisfy a condition of −15≦a*≦15 or ≦15≦b*≦15 for at least one of the images having a recording duty of 10% to 100%.

x: Both of the plain paper and the glossy paper do not satisfy a condition of −20≦a*≦20 or −20≦b*≦20 for at least one of the images having a recording duty of 10% to 100%.

TABLE 3

| | | | | | Color |
|---|---|---|---|---|---|
| | Color | Intermittent | Fastness | | tone/Recording |
| | bleeding | discharging | of an | Recording | medium |
| | property | stability | image | durability | selectivity |
| Example 1 | B | A | A | B | A |
| Example 2 | A | A | A | B | A |
| Example 3 | A | A | A | B | A |
| Example 4 | A | B | A | B | A |
| Example 5 | A | A | A | B | A |
| Example 6 | B | A | A | B | A |
| Example 7 | B | A | A | B | A |
| Example 8 | A | A | A | A | A |
| Example 9 | A | A | A | B | A |
| Example 10 | A | A | A | B | A |
| Example 11 | A | B | A | B | A |
| Example 12 | A | A | A | B | A |
| Example 13 | A | A | A | B | A |
| Example 14 | A | A | B | B | A |
| Example 15 | A | B | B | B | A |
| Example 16 | A | A | A | B | A |
| Example 17 | A | A | B | B | A |
| Example 18 | A | A | A | B | B |
| Example 19 | A | B | A | B | B |
| Example 20 | A | A | B | B | B |
| Example 21 | A | A | B | B | B |
| Example 22 | A | A | A | B | B |
| Example 23 | A | A | A | B | B |
| Example 24 | A | A | A | A | A |
| Comparative Example 1 | C | A | A | B | B |
| Comparative Example 2 | A | C | A | B | A |
| Comparative Example 3 | A | C | A | B | A |
| Comparative Example 4 | B | C | A | B | B |
| Comparative Example 5 | B | C | A | C | C |
| Comparative Example 6 | B | C | A | C | C |
| Comparative Example 7 | C | C | B | B | A |
| Comparative Example 8 | B | C | A | B | B |
| Comparative Example 9 | C | B | A | B | C |
| Comparative Example 10 | C | B | B | B | B |
| Comparative Example 11 | C | B | C | B | C |
| Comparative Example 12 | A | C | C | C | C |

As shown in Table 3, it was evaluated that the ink compositions of Examples 1 to 24 were preferable or particularly preferable in terms of any of the properties of the ink composition, the ink bleeding property, the intermittent discharging stability, the fastness of an image, the recording durability, and the color tone/recording medium selectivity.

Furthermore, in Examples 1 to 4, the conditions were the same as each other except that only the contents of the acetylene glycol-based surfactant were changed. As shown in these Examples, it can be seen that it is preferable that the content of the acetylene glycol-based surfactant be 0.3% by mass or more and 0.5% by mass or less in order to attain compatibility between the color bleeding property and the intermittent discharging property at a high level.

Furthermore, as seen from comparison between Example 3 and Example 24, if MOPS is added as a pH adjuster, the recording durability can be improved. Further, the reason why the recording durability in Example 8 is evaluated as “A” is that the concentration of the dye is lower than those of the other Examples, and since even though the dye concentration is high in Example 24, there is an effect of reducing the cogation by the dye with MOPS, the recording durability can be improved.

Moreover, in Example 18 in which the total amount of the color materials is less than 3.00% by mass, although not shown in Table 3, there was a tendency that the concentration of the recorded matter was slightly insufficient. Further, in Example 19 in which the total amount of the color materials is more than 6.00% by mass, the intermittent discharging stability was evaluated as “B”.

Moreover, in Examples 20 to 23 in which either the ratio of the bisazo dye/the trisazo dye or the ratio of (the bisazo dye+the trisazo dye)/the tetraazo dye was out of the range of the present disclosure, the color tone/recording medium selectivity was evaluated as “B”.

On the other hand, in Comparative Example 1 in which a surfactant was not included, the color bleeding property was deteriorated. Further, in Comparative Examples 2 to 4, the content of the acetylene surfactant was 0.8% by mass or more, the intermittent discharging stability was deteriorated. Further, in Comparative Examples 5 to 12 in which the trisazo compound of the general formula (II) was not included, a result that the color bleeding property was deteriorated was obtained. In addition, in Comparative Examples 11 and 12 in which the bisazo dye of the general formula (I) having excellent fastness was not included, a result that the fastness of an image was deteriorated was obtained.

As described above, the suitable embodiments of the present disclosure were described in detail with reference to the accompanying drawings, but the present disclosure is not limited to the referenced examples. It is apparent for an ordinary skilled person in the art that various modifications or variations can be added without departing from the technical spirit described in the Claims, and it is understood that such modifications or variations are encompassed by the technical scope of the present disclosure.

For example, the embodiments above are described with reference to the constitution of the ink jet recording apparatus and by way of an example of the line type ink jet recording apparatus, but the present disclosure is not limited to these examples. For example, the ink jet recording apparatus according to the embodiment of the present disclosure may be a serial type of an ink jet recording apparatus, in which a recording head reciprocally moves in the direction perpendicular to the transport direction of a recording medium.

The present disclosure contains subject matter related to that disclosed in Japanese Priority Patent Application JP 2010-189255 filed in the Japan Patent Office on Aug. 26, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An ink jet ink composition comprising at least:
a first color material which is a bisazo compound represented by the following general formula (I),
a second color material which is a trisazo compound represented by the following general formula (II),
a third color material which is a tetraazo compound represented by the following general formula (III), and
a surfactant which is a compound having a structure represented by the following general formula (IV), in which the surfactant is contained in an amount of 0.10% by mass or more and less than 0.80% by mass: 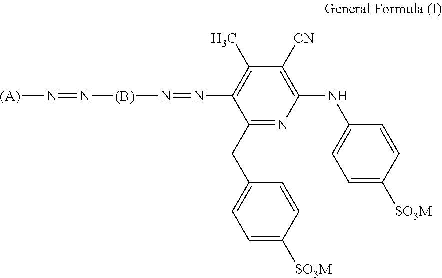
(in the general formula (I), [A] is a group represented by any one of the following general formulae (1) to (4), [B] is a group represented by any one of the following general formulae (5) to (9), and each M is independently a hydrogen atom, an alkali metal, ammonium, or organic ammonium). 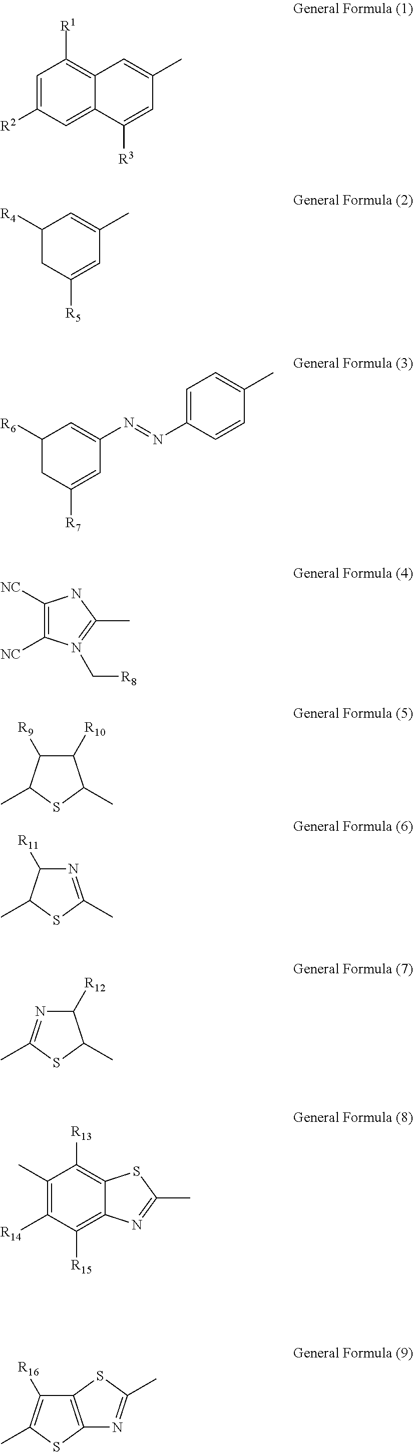
(in the general formulae (1) to (9), R₁ to R₁₆ are each independently a hydrogen atom, a halogen atom, an aliphatic group, an aromatic group, a heterocyclic group, a carboxyl group, a carbamoyl group, an alkoxycarbonyl group, an aryloxycarbonyl group, a heterocyclic oxycarbonyl group, an acyl group, a hydroxyl group, an alkoxy group, an aryloxy group, a heterocyclic oxy group, a silyloxy group, an acyloxy group, a carbamoyloxy group, an alkoxycarbonyloxy group, an aryloxycarbonyloxy group, an aniline group, an amino group including a heterocyclic amino group, an acylamino group, a ureido group, a sulfamoylamino group, an alkoxycarbonylamino group, an aryloxycarbonylamino group, an alkylsulfonylamino group, an arylsulfonylamino group, a heterocyclic sulfonylamino group, a cyano group, a nitro group, an alkylthio group, an arylthio group, a heterocyclic thio group, an alkylsulfonyl group, an arylsulfonyl group, a heterocyclic sulfonyl group, an alkylsulfinyl group, an arylsulfinyl group, a heterocyclic sulfinyl group, a sulfamoyl group, or a sulfonic acid group, each of which is further substituted). 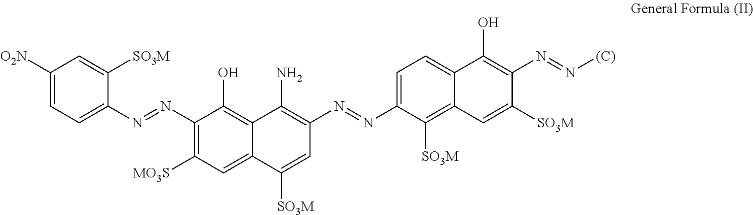
(in the general formula (II), [C] is a phenyl group or a naphthyl group. The phenyl group and the naphthyl group may be substituted with a halogen atom, a carboxyl group, a sulfo group, an alkyl group, a phenyl group, a sulfamoyl group, or a nitro group. Further, each M is independently a hydrogen atom, an alkali metal, ammonium, or organic ammonium). 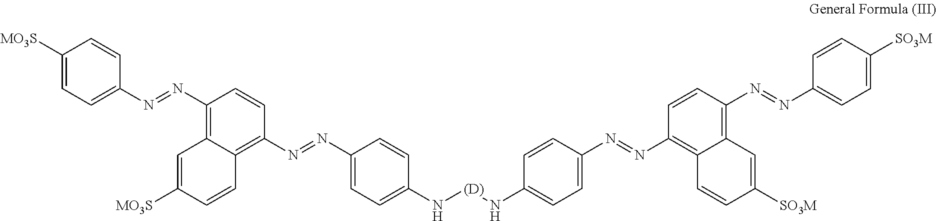
(in the general formula (III), the bridge [D] has the following general formula (10) or (11), and each M is independently a hydrogen atom, an alkali metal, ammonium, or organic ammonium). 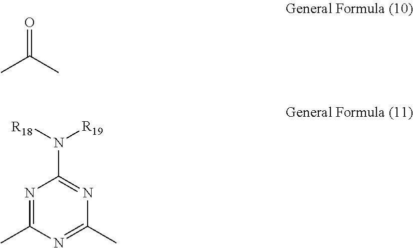
(in the general formula (11), R₁₈ and R₁₉ are each independently a hydrogen atom or a monovalent substituent). 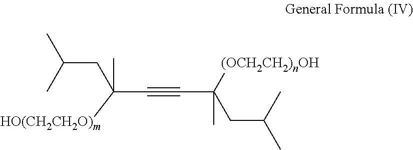
(in the general formula (IV), m and n are an integer of 1 or more).

2. The ink jet ink composition according to claim 1, wherein in the first color material represented by the general formula (I), [A] is any one group represented by the following general formula (12) or the following general formula (13), and [B] is any one group represented by the following general formula (14) or the following general formula (15): 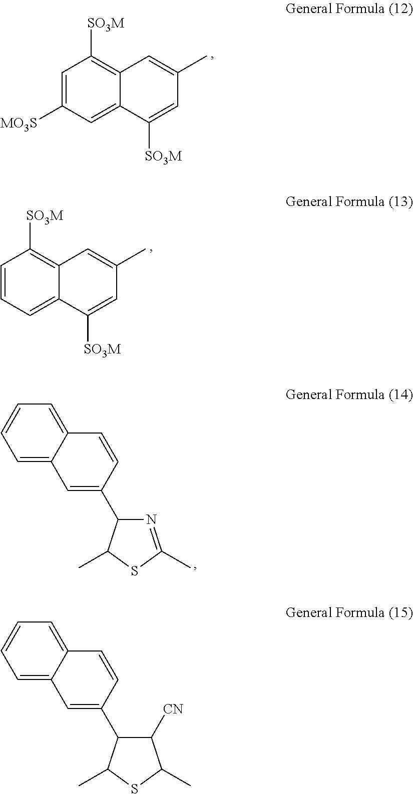
(in the general formula (12) and the general formula (13), each M is independently a hydrogen atom, an alkali metal, ammonium, or organic ammonium).

3. The ink jet ink composition according to claim 2, wherein the second color material is a compound represented by the following general formula (V): 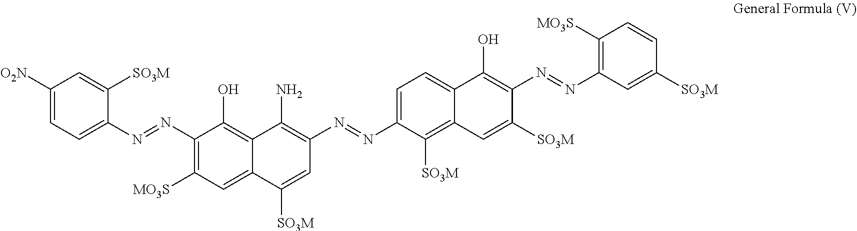
(in the general formula (V), each M is independently a hydrogen atom, an alkali metal, ammonium, or organic ammonium).

4. The ink jet ink composition according to claim 3, wherein the total content of the first color material, the second color material, and the third color material in the ink composition is 3.00% by mass or more and 6.00% by mass or less.

5. The ink jet ink composition according to claim 4, wherein the content (% by mass) of the first color material in the ink composition is 0.50 times or more and 6.00 times or less the content (% by mass) of the second color material in the ink composition in terms of a mass ratio, and
the total content (% by mass) of the first color material and the second color material in the ink composition is 4.00 times or more and 6.00 times or less the content (% by mass) of the third color material in the ink composition in terms of a mass ratio.

6. The ink jet ink composition according to claim 5, wherein the surfactant has an HLB (Hydrophile-Lipophile Balance) value of 10 or more.

7. The ink jet ink composition according to claim 1, further comprising a pH adjuster in an amount of 0.10% by mass or more and less than 0.50% by mass.

8. The ink jet ink composition according to claim 7, wherein the pH adjuster is a 3-morpholinopropanesulfonic acid.

9. An ink jet recording method comprising:
discharging liquid droplets of an ink composition by an ink jet system to perform recording, wherein the ink composition includes at least a first color material which is a bisazo compound represented by the general formula (I), a second color material which is a trisazo compound represented by the general formula (II), a third color material which is a tetraazo compound represented by the general formula (III), and a surfactant which is a compound having a structure represented by the following general formula (IV), in which the surfactant is contained in an amount of 0.10% by mass or more and less than 0.80% by mass: 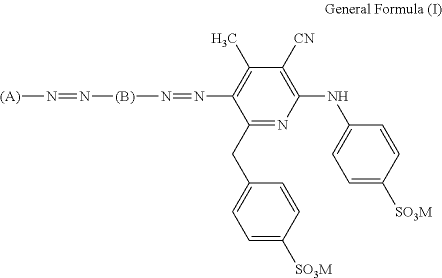
(in the general formula (I), [A] is a group represented by any one of the following general formulae (1) to (4), [B] is a group represented by any one of the following general formulae (5) to (9), and each M is independently a hydrogen atom, an alkali metal, ammonium, or organic ammonium). 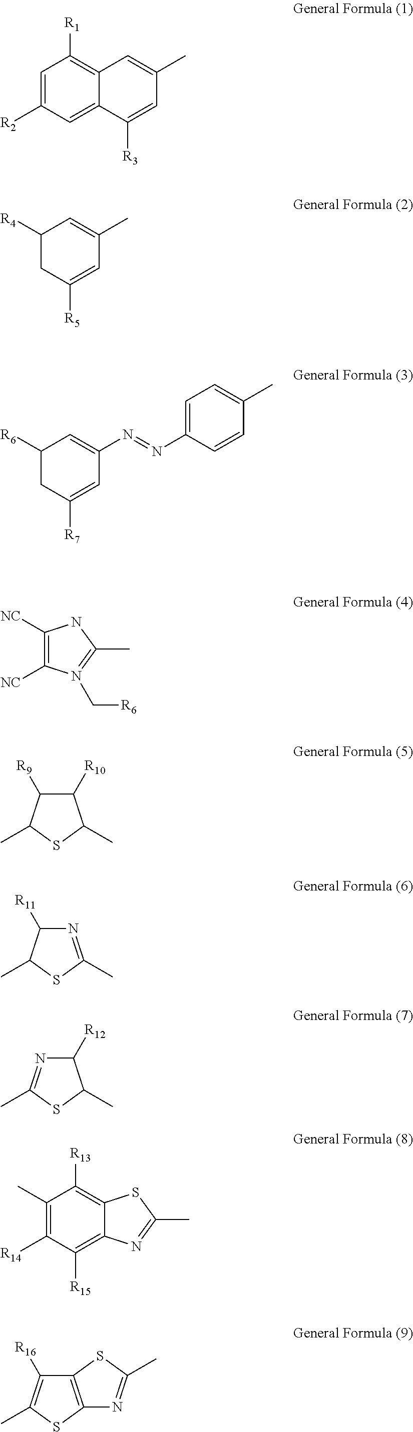
(in the general formulae (1) to (9), R₁ to R₁₆ are each independently a hydrogen atom, a halogen atom, an aliphatic group, an aromatic group, a heterocyclic group, a carboxyl group, a carbamoyl group, an alkoxycarbonyl group, an aryloxycarbonyl group, a heterocyclic oxycarbonyl group, an acyl group, a hydroxyl group, an alkoxy group, an aryloxy group, a heterocyclic oxy group, a silyloxy group, an acyloxy group, a carbamoyloxy group, an alkoxycarbonyloxy group, an aryloxycarbonyloxy group, an aniline group, an amino group including a heterocyclic amino group, an acylamino group, a ureido group, a sulfamoylamino group, an alkoxycarbonylamino group, an aryloxycarbonylamino group, an alkylsulfonylamino group, an arylsulfonylamino group, a heterocyclic sulfonylamino group, a cyano group, a nitro group, an alkylthio group, an arylthio group, a heterocyclic thio group, an alkylsulfonyl group, an arylsulfonyl group, a heterocyclic sulfonyl group, an alkylsulfinyl group, an arylsulfinyl group, a heterocyclic sulfinyl group, a sulfamoyl group, or a sulfonic acid group, each of which is further substituted). 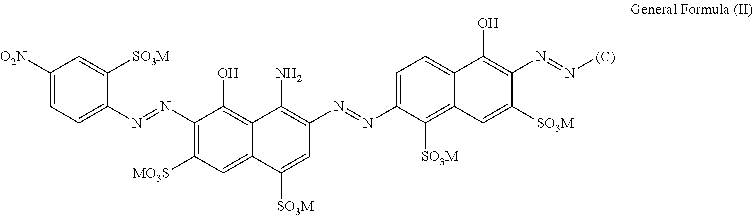
(in the general formula (II), [C] is a phenyl group or a naphthyl group. The phenyl group and the naphthyl group may be substituted with a halogen atom, a carboxyl group, a sulfo group, an alkyl group, a phenyl group, a sulfamoyl group, or a nitro group. Further, each M is independently a hydrogen atom, an alkali metal, ammonium, or organic ammonium). 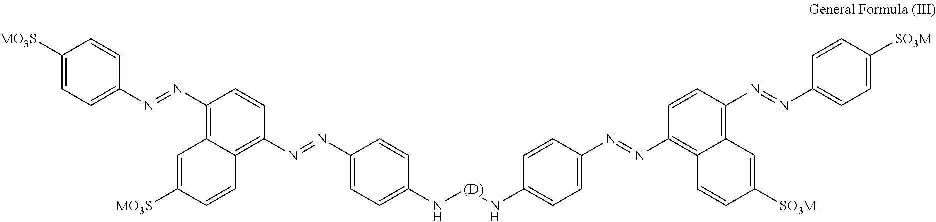
(in the general formula (III), the bridge [D] has the following general formula (10) or (11), and each M is independently a hydrogen atom, an alkali metal, ammonium, or organic ammonium). 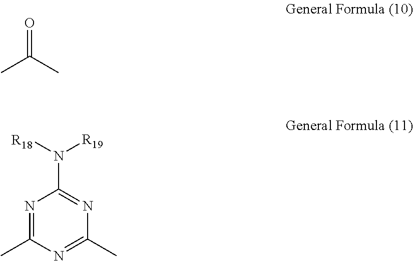
(in the general formula (11), R₁₈ and R₁₉ are each independently a hydrogen atom or a monovalent substituent). 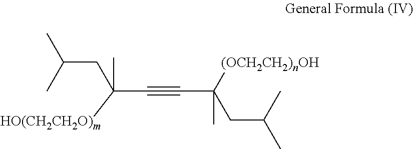
(in the general formula (IV), m and n are an integer of 1 or more).

10. An ink cartridge comprising:
an ink-storing unit for storing an ink jet ink composition including at least a first color material which is a bisazo compound represented by the general formula (I), a second color material which is a trisazo compound represented by the general formula (II), a third color material which is a tetraazo compound represented by the general formula (III), and a surfactant which is a compound having a structure represented by the general formula (IV), in which the surfactant is contained in an amount of 0.10% by mass or more and less than 0.80% by mass: 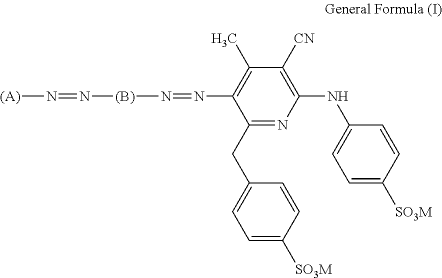
(in the general formula (I), [A] is a group represented by any one of the following general formulae (1) to (4), [B] is a group represented by any one of the following general formulae (5) to (9), and each M is independently a hydrogen atom, an alkali metal, ammonium, or organic ammonium). 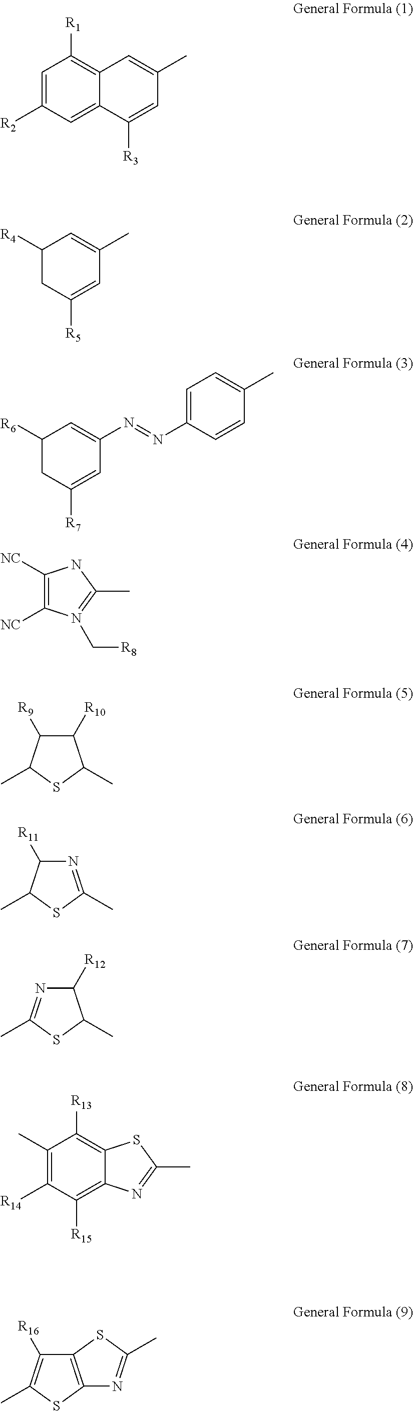
(in the general formulae (1) to (9), R₁ to R₁₆ are each independently a hydrogen atom, a halogen atom, an aliphatic group, an aromatic group, a heterocyclic group, a carboxyl group, a carbamoyl group, an alkoxycarbonyl group, an aryloxycarbonyl group, a heterocyclic oxycarbonyl group, an acyl group, a hydroxyl group, an alkoxy group, an aryloxy group, a heterocyclic oxy group, a silyloxy group, an acyloxy group, a carbamoyloxy group, an alkoxycarbonyloxy group, an aryloxycarbonyloxy group, an aniline group, an amino group including a heterocyclic amino group, an acylamino group, a ureido group, a sulfamoylamino group, an alkoxycarbonylamino group, an aryloxycarbonylamino group, an alkylsulfonylamino group, an arylsulfonylamino group, a heterocyclic sulfonylamino group, a cyano group, a nitro group, an alkylthio group, an arylthio group, a heterocyclic thio group, an alkylsulfonyl group, an arylsulfonyl group, a heterocyclic sulfonyl group, an alkylsulfinyl group, an arylsulfinyl group, a heterocyclic sulfinyl group, a sulfamoyl group, or a sulfonic acid group, each of which is further substituted). 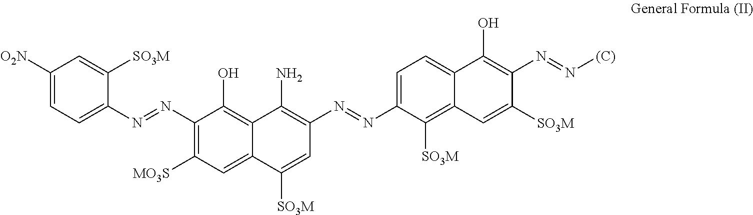
(in the general formula (II), [C] is a phenyl group or a naphthyl group. The phenyl group and the naphthyl group may be substituted with a halogen atom, a carboxyl group, a sulfo group, an alkyl group, a phenyl group, a sulfamoyl group, or a nitro group. Further, each M is independently a hydrogen atom, an alkali metal, ammonium, or organic ammonium). 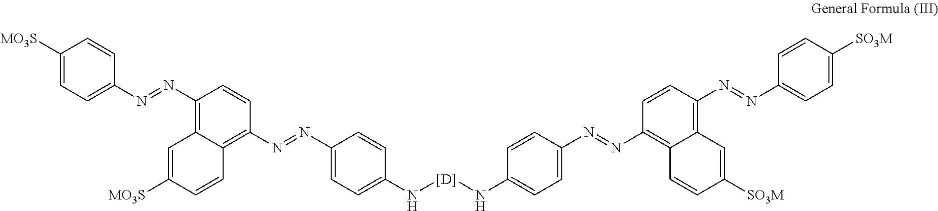
(in the general formula (III), the bridge [D] has the following general formula (10) or (11), and each M is independently a hydrogen atom, an alkali metal, ammonium, or organic ammonium). 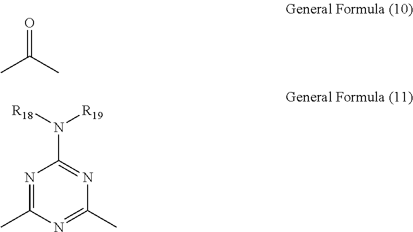
(in the general formula (II), R¹⁸ and R₁₉ are each independently a hydrogen atom or a monovalent substituent). 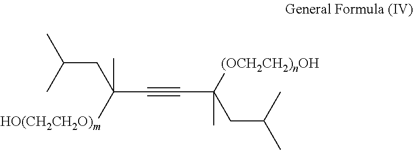
(in the general formula (IV), m and n are an integer of 1 or more).

11. A recording unit including an ink cartridge having an ink-storing unit for storing an ink jet ink composition including at least a first color material which is a bisazo compound represented by the general formula (I), a second color material which is a trisazo compound represented by the general formula (II), a third color material which is a tetraazo compound represented by the general formula (III), and a surfactant which is a compound having a structure represented by the general formula (IV), in which the surfactant is contained in an amount of 0.10% by mass or more and less than 0.80% by mass, and
a recording head for discharging liquid droplets of the ink composition stored in the ink-storing unit: 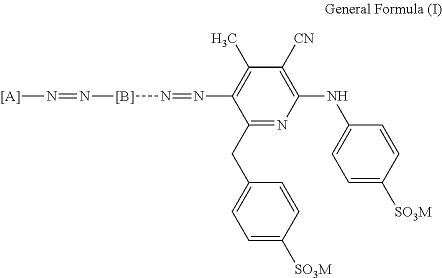
(in the general formula (I), [A] is a group represented by any one of the following general formulae (1) to (4), [B] is a group represented by any one of the following general formulae (5) to (9), and each M is independently a hydrogen atom, an alkali metal, ammonium, or organic ammonium). 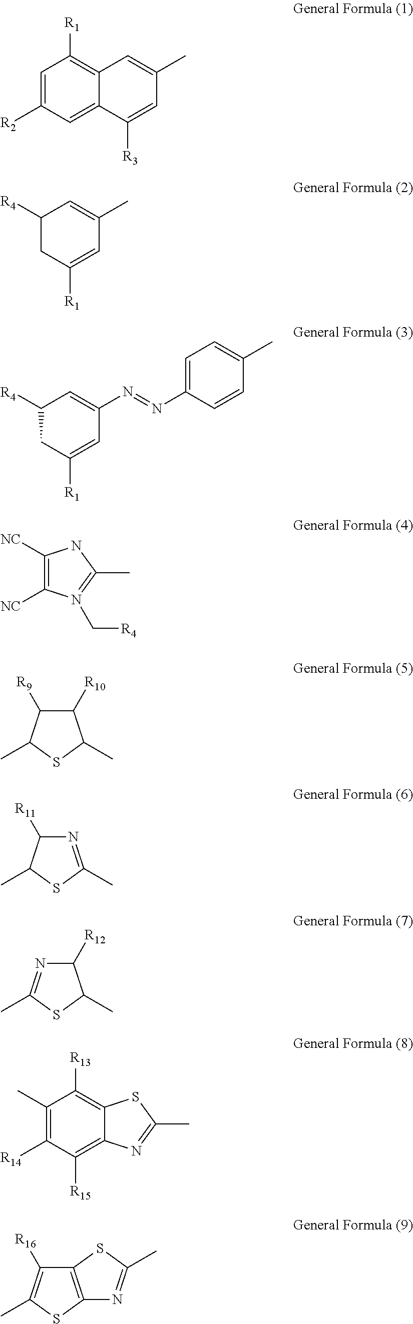
(in the general formulae (1) to (9), R₁ to R₁₆ are each independently a hydrogen atom, a halogen atom, an aliphatic group, an aromatic group, a heterocyclic group, a carboxyl group, a carbamoyl group, an alkoxycarbonyl group, an aryloxycarbonyl group, a heterocyclic oxycarbonyl group, an acyl group, a hydroxyl group, an alkoxy group, an aryloxy group, a heterocyclic oxy group, a silyloxy group, an acyloxy group, a carbamoyloxy group, an alkoxycarbonyloxy group, an aryloxycarbonyloxy group, an aniline group, an amino group including a heterocyclic amino group, an acylamino group, a ureido group, a sulfamoylamino group, an alkoxycarbonylamino group, an aryloxycarbonylamino group, an alkylsulfonylamino group, an arylsulfonylamino group, a heterocyclic sulfonylamino group, a cyano group, a nitro group, an alkylthio group, an arylthio group, a heterocyclic thio group, an alkylsulfonyl group, an arylsulfonyl group, a heterocyclic sulfonyl group, an alkylsulfinyl group, an arylsulfinyl group, a heterocyclic sulfinyl group, a sulfamoyl group, or a sulfonic acid group, each of which is further substituted). 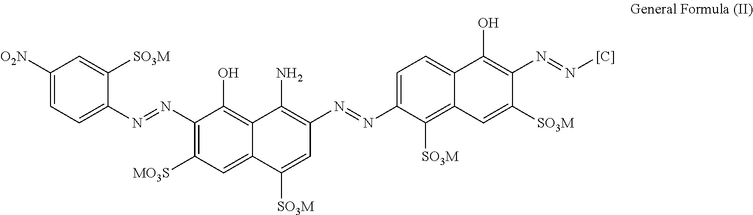
(in the general formula (II), [C] is a phenyl group or a naphthyl group. The phenyl group and the naphthyl group may be substituted with a halogen atom, a carboxyl group, a sulfo group, an alkyl group, a phenyl group, a sulfamoyl group, or a nitro group. Further, each M is independently a hydrogen atom, an alkali metal, ammonium, or organic ammonium). 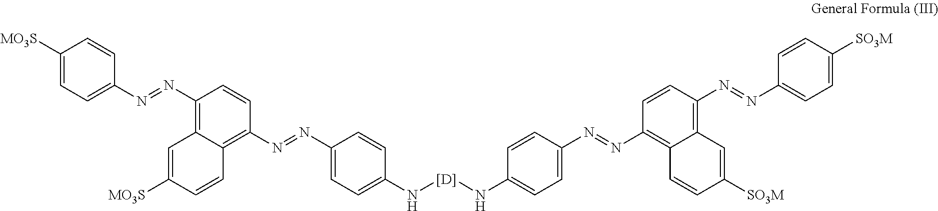
(in the general formula (III), the bridge [D] has the following general formula (10) or (11), and each M is independently a hydrogen atom, an alkali metal, ammonium, or organic ammonium). 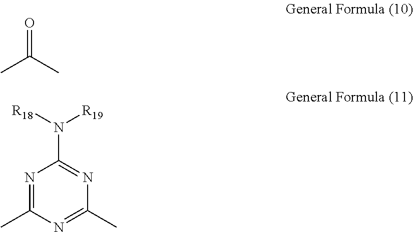
(in the general formula (11), R₁₈ and R₁₉ are each independently a hydrogen atom or a monovalent substituent). 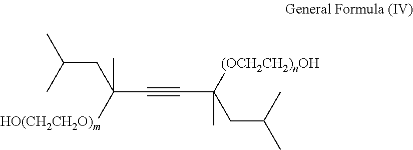
(in the general formula (IV), m and n are an integer of 1 or more).

12. An ink jet recording apparatus comprising:
an ink cartridge having an ink-storing unit for storing an ink jet ink composition including at least a first color material which is a bisazo compound represented by the general formula (I), a second color material which is a trisazo compound represented by the general formula (II), a third color material which is a tetraazo compound represented by the general formula (III), and a surfactant which is a compound having a structure represented by the general formula (IV), in which the surfactant is contained in an amount of 0.10% by mass or more and less than 0.80% by mass, and
a recording head for discharging liquid droplets of the ink composition stored in the ink-storing unit: 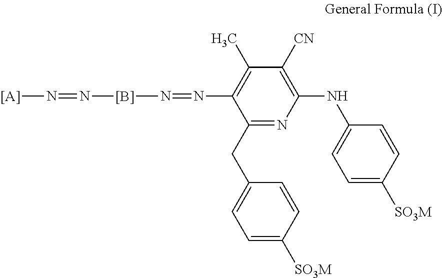
(in the general formula (I), [A] is a group represented by any one of the following general formulae (1) to (4), [B] is a group represented by any one of the following general formulae (5) to (9), and each M is independently a hydrogen atom, an alkali metal, ammonium, or organic ammonium). 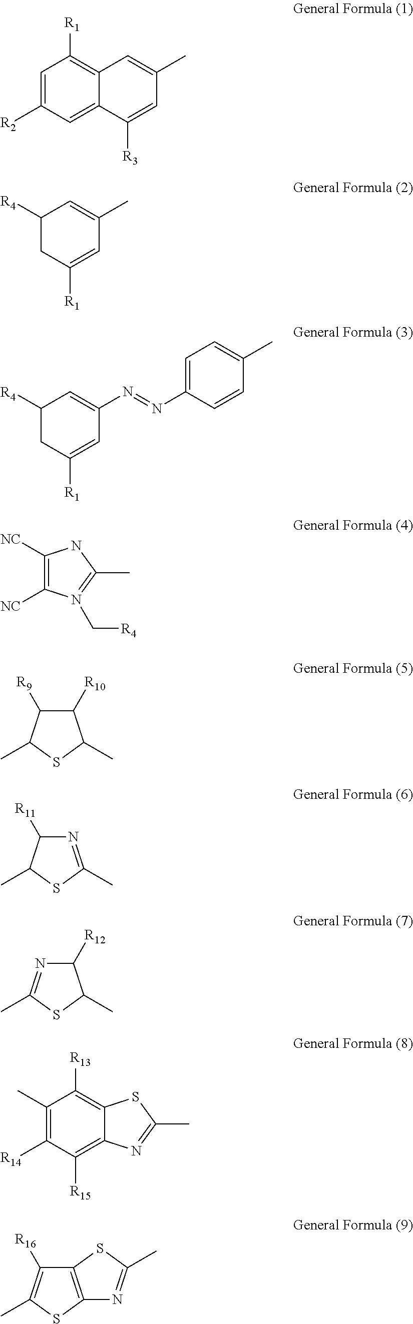
(in the general formulae (1) to (9), R₁ to R₁₆ are each independently a hydrogen atom, a halogen atom, an aliphatic group, an aromatic group, a heterocyclic group, a carboxyl group, a carbamoyl group, an alkoxycarbonyl group, an aryloxycarbonyl group, a heterocyclic oxycarbonyl group, an acyl group, a hydroxyl group, an alkoxy group, an aryloxy group, a heterocyclic oxy group, a silyloxy group, an acyloxy group, a carbamoyloxy group, an alkoxycarbonyloxy group, an aryloxycarbonyloxy group, an aniline group, an amino group including a heterocyclic amino group, an acylamino group, a ureido group, a sulfamoylamino group, an alkoxycarbonylamino group, an aryloxycarbonylamino group, an alkylsulfonylamino group, an arylsulfonylamino group, a heterocyclic sulfonylamino group, a cyano group, a nitro group, an alkylthio group, an arylthio group, a heterocyclic thio group, an alkylsulfonyl group, an arylsulfonyl group, a heterocyclic sulfonyl group, an alkylsulfinyl group, an arylsulfinyl group, a heterocyclic sulfinyl group, a sulfamoyl group, or a sulfonic acid group, each of which is further substituted). 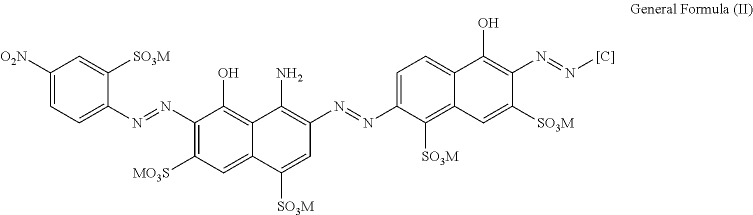
(in the general formula (II), [C] is a phenyl group or a naphthyl group. The phenyl group and the naphthyl group may be substituted with a halogen atom, a carboxyl group, a sulfo group, an alkyl group, a phenyl group, a sulfamoyl group, or a nitro group. Further, each M is independently a hydrogen atom, an alkali metal, ammonium, or organic ammonium). 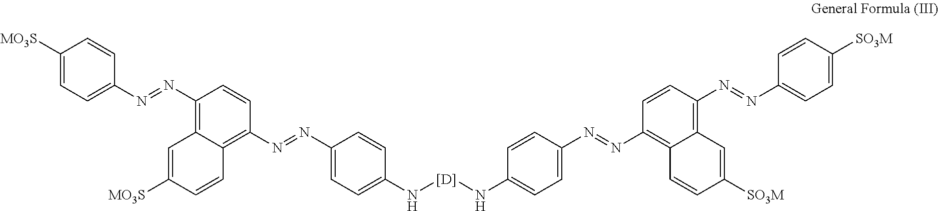
(in the general formula (III), the bridge [D] has the following general formula (10) or (11), and each M is independently a hydrogen atom, an alkali metal, ammonium, or organic ammonium). 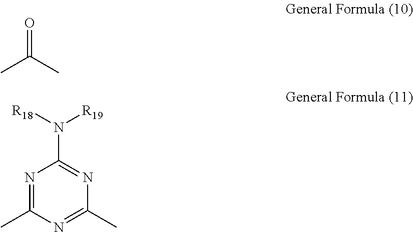
(in the general formula (11), R₁₈ and R₁₉ are each independently a hydrogen atom or a monovalent substituent). 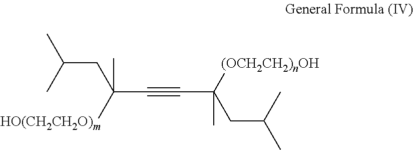
(in the general formula (IV), m and n are an integer of 1 or more).
